(19) United States
(12) Patent Application Publication
(10) Pub. No.: US 2006/0036524 A1
(43) Pub. Date: Feb. 16, 2006

(54) Method and apparatus for capture and application of legal personal net worth information

(76) Inventor: Paloma A. Capanna, Pittsford, NY (US)

Correspondence Address: Thomas R. FitzGerald, Esq., Suite 210, 16 E. Main Street, Rochester, NY, 14614-1808, US

(21) Appl. No.: 11/132,160

(22) Filed: May 17, 2005

Related U.S. Application Data
(60) Provisional application No. 60/572,255, filed on May 18, 2004.

(51) Int. Cl. G06Q 40/00

(52) U.S. Cl. 705/35

(57) ABSTRACT

A program and database with interactive forms operating on a personal computer or workstation to allow a user to capture, store, retrieve, and report on all legally required information defining an individual person's net worth, for official use in civil legal proceedings. The user sees logically-related sequence of requests for input, while navigating conveniently to specific points in the sequence. Non-relevant forms are suppressed. Partial completion of inputs and resumption of input requests is done at the user's convenience. Valid and consistent relationships are established and maintained among data elements stored. The primary output is a statement of net worth which meets all New York State requirements for content and presentation.

### CROSS-REFERENCE TO RELATED APPLICATIONS

This application claims priority to U.S. provisional patent application No. 60/572,255 filed May 18, 2004.

### FIELD OF THE INVENTION

This invention relates to the acquisition, storage and retrieval of legal data, and more specifically to the acquisition, storage and retrieval of personal net worth information for use in legal proceedings.

### BACKGROUND OF THE INVENTION

Legal proceedings such as civil divorce actions require the accurate capture, reliable retention, and correct use of numerous and varied elements of information. In a civil divorce action, the capture, retention, and application processes for both plaintiff and defendant are necessarily time-consuming. When the time required is coupled with the high cost of the legal services needed to support these processes, the results can create considerable expense for the client or clients requiring them.

The overall breakdown of data elements to be selected, gathered, and evaluated for a Statement of Net Worth in the state of New York is approximately as follows (using the 1998 paper forms):

Family data: 19 separate categories of data—numeric, dollar amounts, text, checkboxes, and lists;

Expenses: 15 separate categories of data—dollar amounts, numeric, text, and lists;

Gross Income: 19 separate categories of data—dollar amounts, numeric, text, and lists;

Assets: 12 major categories of data, each divided into subcategories totaling 29 across all 12 categories, and each subcategory further divided into 2-10 identifying elements—dollar amounts, numeric, text, and dates;

Liabilities: 8 major categories of data, each divided into subcategories totaling 15 across all 8 categories, and each subcategory further divided into 3-8 identifying elements—dollar amounts, numeric, text, and dates;

Assets Transferred: a list of 4 entries, with 4 elements per entry (all lists may be extended as required);

Support Requirements: 4 categories of data with 1-5 elements per category;

Counsel Fee Requirements: 3 categories of data with 1-3 elements per category;

Account and Appraisal Fees Requirements: 4 categories of data with 1-2 elements per category;

Other Data: free-form text.

The total number of categories is about 90, encompassing hundreds of individual data elements. Complicating matters further, many categories may require extension to include items exceeding the space, line count, or entry count available for them on the paper form. Finally, many categories require arithmetic consistency among data elements, particularly in summing dollar amounts. Such volume and complexity of data present frequent chances for error, especially when a data element must be transcribed to or from a place on the paper form.

Some attempts have been made to develop and apply automated forms. Due to their limitations in the acceptable handling of all required data, these attempts have had only restricted use. Consequently, the completion of the statement of net worth continues to present a costly obstruction and delay in civil divorce actions. A convenient, accurate, straightforward, and rapid automation of the completion process for the statement of net worth would serve both law offices and their clients well.

### SUMMARY OF THE INVENTION

The invention incorporates computer database software and storage with interactive forms on a personal computer or workstation to allow a user to capture, store, retrieve, and report on all legally required information defining an individual person's net worth, for official use in civil legal proceedings. The invention presents the user with a logically-related sequence of requests for input, while allowing the user to navigate conveniently to specific points in the sequence. The invention conditionally suppresses the presentation of all non-relevant forms and requests based on user inputs. The invention provides for partial completion of inputs and resumption of input requests at the user's convenience. The invention establishes and maintains valid and consistent relationships among data elements it stores. The invention produces as its primary output a statement of net worth which meets all New York State requirements for content and presentation.

### BRIEF DESCRIPTION OF THE DRAWINGS

FIG. 1 shows a diagrammatic overview of the invention.

FIG. 2 shows the invention's toolbar and overall screen.

FIG. 3 shows the invention's navigation bar on the overall screen.

FIG. 4 shows the invention's display of its print options menu.

FIG. 5 shows the invention's display of its owned marital residence information screen.

FIG. 6 shows the invention's display of its drop-down menu for the source of funds for a cash account asset.

FIG. 7 shows the program flow for the updating of information in a specific category.

FIG. 8 shows the program flow for deleting an occurrence of a category of information having multiple occurrences.

FIG. 9 shows the program flow for the invention's navigation bar.

FIG. 10 shows the opening program flow for either establishing a new client or retrieving an existing client's information.

FIGS. 11 and 12 show an example of program flow for multiple occurrences of a set of data elements, this example for children in common.

FIG. 13 shows the program flow for a typical selection menu, this example for either party (plaintiff or defendant).

FIG. 14 shows the program flow for the general information identifying a party.

FIG. 15 shows the program flow for validating a user's choice of rental or owned marital residence.

FIG. 16 shows the overall program flow for requesting and validating information concerning an owned marital residence.

FIG. 17 shows the program flow for requesting and validating cash down payment information concerning an owned marital residence.

FIG. 18 shows the program flow for requesting and validating client job pay stub overview information.

FIG. 19 shows the program flow for requesting and validating client job pay stub detailed information.

FIG. 20 shows the program flow for requesting and validating client job pay stub year-to-date information.

FIG. 21 shows the program flow for requesting and validating client job W-2 information.

FIG. 22 shows the program flow for requesting and validating client sole proprietorship information.

FIG. 23.1 shows the program flow for requesting and validating client unemployment payment information.

FIG. 23.2 shows the program flow for requesting and validating client other income information.

FIG. 23.3 shows the program flow for requesting and validating client dividend income information.

FIG. 24 shows the program flow for requesting and validating occurrences of asset cash account checking account information.

FIG. 25 shows the program flow for requesting and validating the number of occurrences of asset vehicle information.

FIG. 26 shows the program flow for requesting and validating each occurrence of asset vehicle information, including liens.

FIG. 27 shows the program flow for requesting and validating occurrences of asset real estate information.

FIG. 28 shows the program flow for requesting and validating information on asset real estate mortgages and equity lines of credit.

FIG. 29 shows the program flow for requesting and validating housing expense information, noting the accumulation of total housing expense.

### DETAILED DESCRIPTION OF THE INVENTION

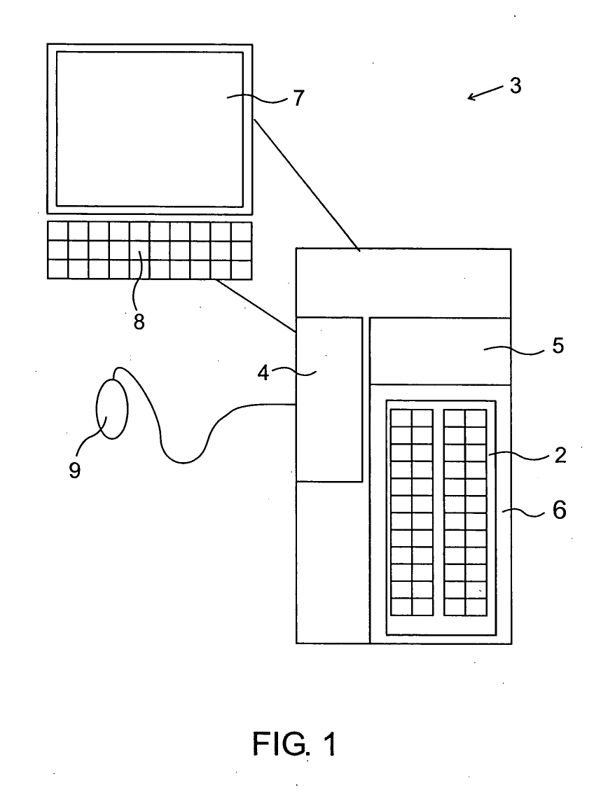

The structure of the invention is as shown in FIG. 1. The invention comprises a client database 2 stored in a workstation or personal computer 3 having a processor 4, a main memory 5, a data storage subsystem 6, a display device such as a screen 7, and input devices such as a keyboard 8 and a mouse 9. The invention also comprises a set of menus displayable on the display device for user selection of categories of net worth information to be entered or retrieved, and a set of interlinked screens displayable on the computer for user entry, change, or retrieval of net worth information. The invention further comprises a program operating in the personal computer 3 for displaying menus and screens to a user, for validating net worth information entered by a user, for storing and retrieving net worth information in the client database 2, and for informing the user of consistency and completeness criteria to be met by the net worth information entered.

The user operates the program using a text entry device such as a keyboard 8 for entering data and a pointing device such as a mouse 9 for selecting items displayed on the screen.

The Invention's Database

The invention uses a relational database management program to manage the entry, storage, retrieval, updating, removal, and reporting of information for each client. The invention uses a set of relational tables maintained through the relational database management program to contain an organized form of client information for each client.

The invention's database provides for the independent storage and retrieval of net worth information for a large number of clients. The net worth information storable in the database encompasses all types of net worth information required by the New York State legal system.

The Invention's User Interface

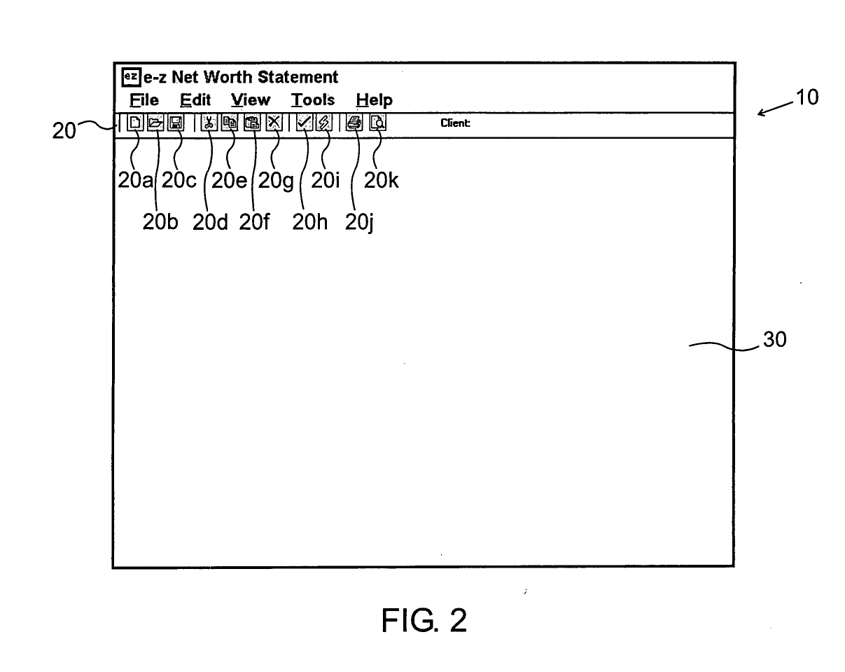

See FIG. 2. The invention's interface for the user comprises a single screen 10 with a toolbar 20 and a display area 30. The toolbar contains icons for commonly-used operations: an icon 20a for creating a new client's database component, an icon 20b for opening an existing client's database component, an icon 20c for saving the current client's information, an icon 20d for cutting data from a value in a data element's display, an icon 20e for copying data from a value in a data element's display, an icon 20f for pasting data into a data element's display, an icon 20g for clearing the value from a data element's display, an icon 20h for checking the validity of one or more data values, an icon 20i for displaying a navigation menu, an icon 20j for printing one or more sections of the Statement of Net Worth report, and an icon 20k for previewing one or more sections of the Statement of Net Worth report to be printed.

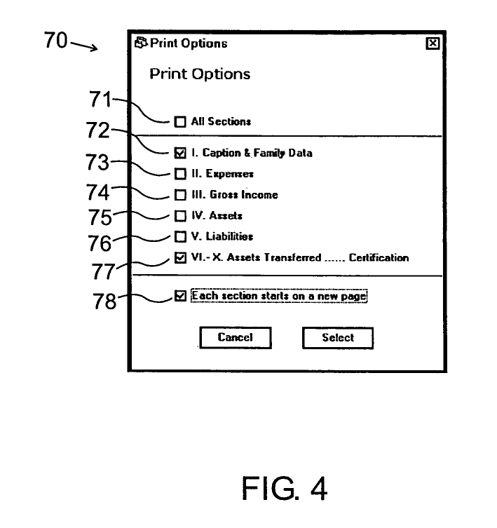

See FIG. 4 for the Print Options selection display 70. The invention allows the user to preview and print selectively one, several, or all sections of the Statement of Net Worth report, using checkboxes 71 through 77 for section selection, and checkbox 78 for page break selection.

The invention uses the display area 30 to present selection menus to the user, to present client information to the user in an organized form, to accept user input of client information, and to notify the user of possible problems or errors in the entry of client information.

The invention's menus include first a client file menu listing the clients for whom net worth data is being gathered and prepared. Before any other action can be taken, the user of the invention must select a client or else enter a new client name. If an existing client name is specified, the invention uses the portion of its database reserved solely for the data of the specified client. If a new client name is entered, the invention allocates a new client portion of its database reserved solely for the data of the new client.

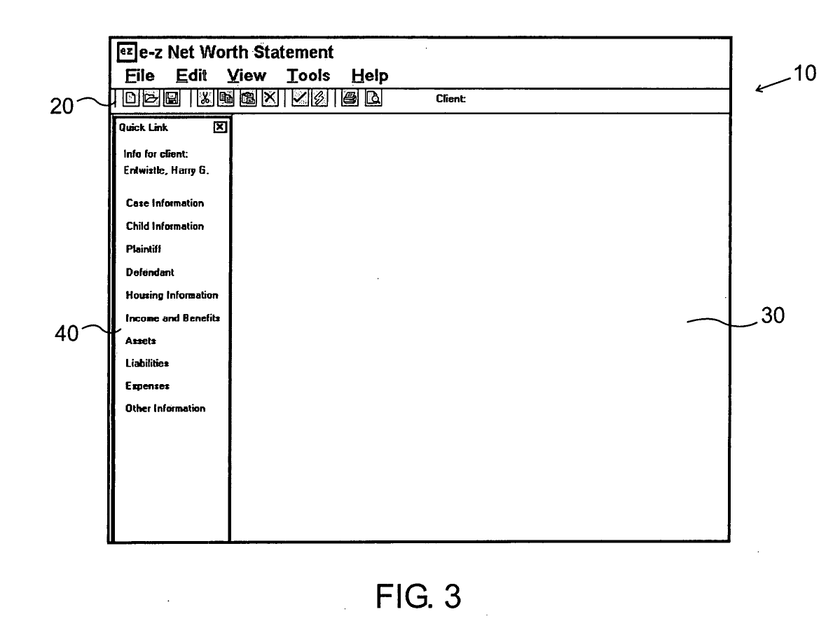

See FIG. 3. The invention incorporates a selectable navigation menu 40 to allow a user to address a specific category of interest in a particular case. The navigation menu may be selected by a mouse click on a specific icon on the invention's toolbar 20. The navigation menu, called a Quick Link menu, lists the client's name, followed by the different categories of client data: case, children in common to the couple, plaintiff, defendant, housing, income and benefits, assets, liabilities, expenses, and other information.

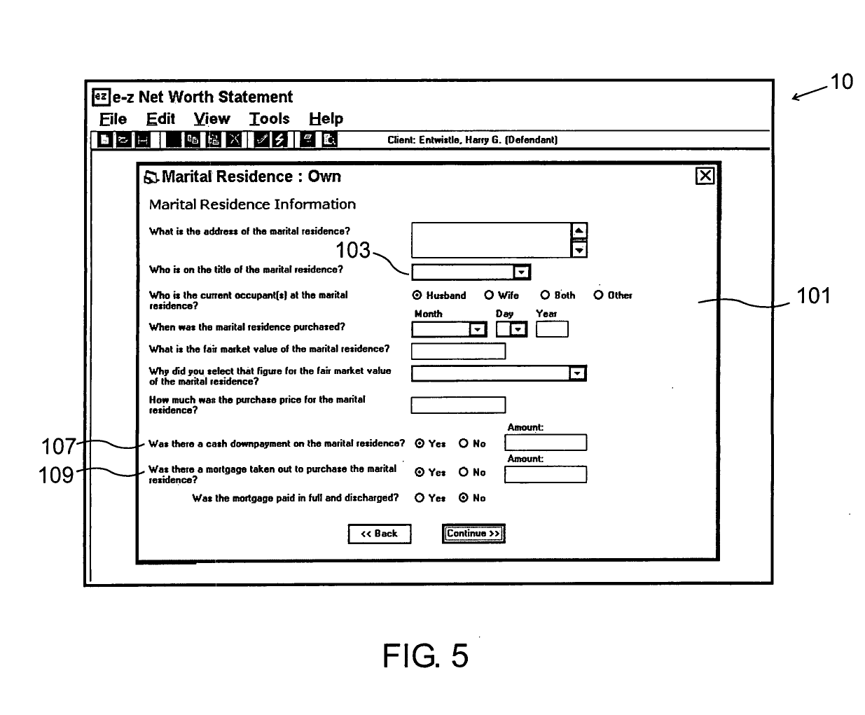

A typical data entry screen 101 of the invention is shown in FIG. 5 for the entry of information concerning an owned marital residence. The invention uses a drop-down menu 103 to let the user specify properly the name(s) on the title of the marital residence. For cash down payment query 107 and mortgage query 109, the invention uses radio buttons to trigger the display of screens for each of those two categories of data if specified by the user.

Overall Category Breakdown of Client Data

The invention breaks down each of the categories of client data into major subcategories, minor subcategories, and data elements grouped on screens as needed.

The case information category has no subcategories, and comprises a series of screens for determining whether the client is the plaintiff or defendant, for entering the case reference information, and for entering the marriage information for the couple involved.

The child information category has no subcategories, and comprises a series of screens for recording the number of children, the identity and status of each child, custody order information, and support information.

The plaintiff information category comprises multiple major subcategories: personal information, address, education, employment, and other children. The defendant information category comprises multiple major subcategories; the major subcategories are the same as for the plaintiff. Each subcategory comprises a series of screens for recording the information needed in that subcategory. To select a major subcategory, the user selects the title of that category.

The housing information category has no subcategories, and comprises a series of screens, for recording whether the marital residence is rented or owned, and for recording the rental arrangements if rented. If the marital residence is owned, the invention's screens provide for recording the value of the marital residence, the sources of its financing, its taxes and insurance costs, and any liens outstanding against it.

The income and benefits information category has no subcategories, and comprises a series of screens for recording wage and other income information using the client's W-2 forms, paystubs, and all other sources.

The asset information category comprises a long list of major subcategories. Asset major subcategories comprise the following: cash accounts; securities; loans to others and accounts receivable from others; business ownership and value; life insurance; vehicles; real estate; retirement assets; contingent interests; household furnishings; jewelry, art, antiques, precious objects, gold and precious metals; and other, including tax shelter investments, collections, judgments, causes of action, patents, trademarks, copyrights, and other assets not covered by the preceding major subcategories. Each subcategory not having minor subcategories comprises a series of screens for recording the information needed in that subcategory.

The cash accounts major subcategory is divided into minor subcategories as follows: cash, checking accounts, savings accounts, real estate, and other. The securities major subcategory is divided into minor subcategories as follows: bonds, notes, and bills; stocks, options, and commodity contracts; broker margin accounts; and other. Each minor subcategory comprises a series of screens for recording the information needed in that minor subcategory.

For asset information, major and minor subcategories are displayed on a single menu with minor subcategories indented under their parent major subcategories. The user selects a subcategory by selecting its title on the screen.

The liabilities information category comprises a list of subcategories. Liabilities major subcategories comprise the following: accounts payable, notes payable, installment accounts payable, brokers' margin accounts, mortgages payable on real estate, taxes payable, loans on life insurance policies, and other liabilities.

The expenses information category comprises a list of subcategories. Expenses subcategories comprise the following: housing, utilities, food, clothing, laundry, insurance, unreimbursed medical, household maintenance, domestic labor, automotive, educational, recreational, miscellaneous, and other expenses. Each subcategory comprises a series of screens for recording the information needed in that subcategory.

The other information category comprises a series of screens for recording support requirements, counsel fee requirements, accountant and appraisal fee requirements, and other relevant financial information not covered elsewhere.

Use and Entry of Items of Information

To acquire, review, correct, and update specific items of information, the invention incorporates screen forms presented to the user for each information category. The invention simplifies and speeds the accurate entry and use of information items in at least the following nine ways.

1. First, the invention presents its screens to the user so that the easiest path of navigation leads through only a minimum number of screens. This approach optimizes the entry, review, and modification of data items in the most common types of cases.

2. Second, the invention presents interrelated items on a single screen for the user, presenting them on multiple screens only when there are too many such items or the items are not closely related.

3. Third, the invention presents only those screen forms required for a specific case. If certain conditions requiring additional information are not met, the screens for the additional information are not presented to the user at all.

4. Fourth, the invention uses the user's count of a particular item's occurrences to present exactly the number of screens needed to obtain or review all required information. Examples include the number of children, the number of residences, the number of checking accounts, and the number of vehicles.

5. Fifth, the invention provides the Quick Links menu to allow a user to skip directly to a category of interest.

6. Sixth, the invention uses drop-down menus of standard phrasings and choices used in the production of a legal Statement of Net Worth, eliminating the need for the user to type in such standard phrasings and choices by hand.

7. Seventh, the invention tracks and subtotals values in all categories and subcategories of worth, accumulating the values in all categories into a summary statement of total assets, total liabilities, and net worth.

8. Eighth, the invention validates text and numeric values entered by the user in cases where commonsense rules or observations on consistency would ordinarily be applied by someone not using the invention.

9. Ninth, the invention uses information gathered in one category to simplify the gathering of information in another category, thereby eliminating cases where the same information would be separately required for posting in different categories.

Minimum Screens Required in Simple Cases (Point 1)

The invention presents screens to the user so that the easiest path of navigation leads through only a minimum number of screens (Point 1). The invention allows the user to pass through all the key categories of information simply and quickly by clicking on (selecting) the Continue button on each screen, and filling in the minimum necessary information. In the simplest cases, the information to be filled in includes only the following screens: client name; client information (plaintiff/defendant); case information; marriage information; children number query; plaintiff information (with screens for residence, education, skills, employment status, other children); defendant information (with screens for residence, education, skills, employment status, other children); marital residence (with screens for rental information or home ownership depending on the response to the ‘rent or own’ question); government assistance benefits; other income; income of other household members; assets (with screens for each subcategory of assets); liabilities (with screens for each subcategory of liabilities); expenses (with screens for each subcategory of expenses); support requirements; counsel fee requirements; and accountant and appraisal fee requirements. With the exceptions of the client, plaintiff, and defendant names and sexes, no initial entry is required on any of these screens.

Presenting Related Items on the Same Screen (Point 2)

The invention presents interrelated items on a single screen for the user. The invention consistently presents closely-related information items on the same screen on screens in the Expenses category such as Utilities, Food, Clothing, Laundry, Household Maintenance, Domestic Labor, or Educational. To avoid confusion, the invention places an approximate ceiling on the number of items to be displayed on the same screen, as in the case of government assistance benefits, which require two screens for a full list of categories.

Suppression of Unnecessary Displays (Point 3)

The invention presents only those screen forms required for a specific case. The invention consistently suppresses display of screens for which no information is needed from a particular client. For example, a user entering data for a client having no children in common with the other party will not be presented with the screens requesting child information and custody information. This feature of the invention is applied to its implementation in the following areas.

In the plaintiff and defendant education categories, screen queries for degrees are only presented when degrees are checked.

In the plaintiff and defendant employment status categories, screen queries for employment, self-employment, unemployment, retirement, and disability information are only presented when the appropriate employment status subcategory is checked.

In the plaintiff and defendant other children categories, screen queries for child information and child support information are only presented when at least one child is listed, and at least one support order is listed.

In the marital residence category for an owned residence, screen queries for details of the mortgage cash down payment are only presented when a cash down payment was entered. Other mortgage details such as taxes, insurance, and liens are likewise bypassed if no mortgage exists.

In the marital residence category for a rented residence, screen queries for details of the security deposit and renter's insurance are only presented when a security deposit and/or insurance entry is marked.

In the income and benefits category, screen queries for pay stub details are only presented when readiness for supplying such information is marked.

In the income and benefits category, screen queries for a specific other source of income is only presented when that specific other source of income is checked. In the same category, screen queries for income from other household members are only presented when one or more such household members are noted.

In the assets category, screen queries for details on a particular type of asset are only presented when at least one of that particular type of asset is noted as present. The user indicates the presence of one or more checking accounts by marking a check box and entering the number of accounts where requested. In the absence of such an entry, the screen requesting checking account details is bypassed. If one or more checking accounts is marked as present, the screen requesting checking account details is presented.

The treatment provided in the example for checking accounts applies to all asset categories: cash accounts, including cash, checking accounts, savings accounts, real estate accounts, other cash accounts; securities, including bonds, notes and bills, stocks, options, and commodity contracts, broker and margin accounts, and other securities; loans and accounts receivable; business ownership and value; life insurance; vehicles; real estate; retirement assets; contingent interests; household furnishings; jewelry, art, antiques, precious objects, and gold and precious metals; and other assets.

In the liabilities category, screen queries for details on a particular type of liability are only presented when at least one of that particular type of liability is noted as present. The user indicates the presence of one or more accounts payable by marking a check box and entering the number of accounts where requested. In the absence of such an entry, the screen requesting accounts payable details is bypassed. If one or more accounts payable is marked as present, the screen requesting accounts payable details is presented.

The treatment provided in the example for accounts payable applies to all liability categories: accounts payable, notes payable, installment accounts payable, brokers' margin accounts payable, mortgages payable, taxes payable, loans on life insurance payable, and other liabilities.

In the expenses category, screen queries for details on house and vehicle expenses are presented as many times as houses and vehicles are listed as assets.

When the user selects the ‘Back’ button in a series of screens for which some inputs do not exist, the program ‘hunts’ backward until it finds a category of data for which the user has specified that input is required. The effect is to treat a single ‘Back’ selection as a series of ‘Back’ selections until required input is found. Required input is any category for which the user has indicated that one or more items exist.

Occurrence Counting (Point 4)

The invention uses the user's count of a particular item's occurrences to present exactly the number of screens needed to obtain or review all required information. Examples include the number of children in common, plaintiff's other children, defendant's other children, and most subcategories under liabilities and assets. Examples under liabilities and assets include the number of installnent accounts payable, the number of checking accounts, and the number of vehicle assets.

In cases such as the number of pieces of real estate declared as assets, the invention applies the entered number of pieces of real estate declared when presenting other subcategories in other categories, thereby reducing the likelihood of omissions of declaration in the other subcategories. In the case of the number of pieces of real estate declared as assets, the invention presents one screen for housing expenses for each piece of real estate declared as an asset.

The invention provides a “Delete Record” button on screens where multiple item occurrences are available. The user may delete a displayed record by selecting the “Delete Record” button. The invention deletes the displayed record, reduces the number of occurrences of the same type of record by one, and displays the next record of the same type (or the previous record of the same type, if no next such record is present). If no record of the same type is present, the invention displays the next screen in the normal sequence of presentation.

Quick Links (Point 5)

The invention uses the Quick Links menu to allow a user to skip directly to a category of interest. When the user selects the quick link icon, the invention displays a menu of categories at one side of the screen, leaving the current category screen visible in the center.

Standard Legal Language Presentation (Point 6)

The invention uses drop-down menus of standard phrasings and choices to be used for specific items of information. The invention's standard phrasings and choices reflect the most common legal usages for the items for which they are to be entered. The list of items for which such menu selections are provided includes:

County name for the case

Marital status

State and country

Custody Order—available choices include the following texts:

“The Husband is the sole custodian.”

“The Wife is the sole custodian.”

“The Husband and Wife have joint custody, and the Husband is the primary residential parent.”

“The Husband and Wife have joint custody, and the Wife is the primary residential parent.”

“The Husband and Wife have shared custody.”

“The children are split between the Husband and Wife.”

“Other.”—space provided for explanation

Reason for selecting a figure for fair market value of a residence—available choices include the following texts:

“Written Appraisal”

“Current Listing Agreement”

“Estimate by Husband”

“Estimate by Wife”

“Tax Assessed Value”

“Other”

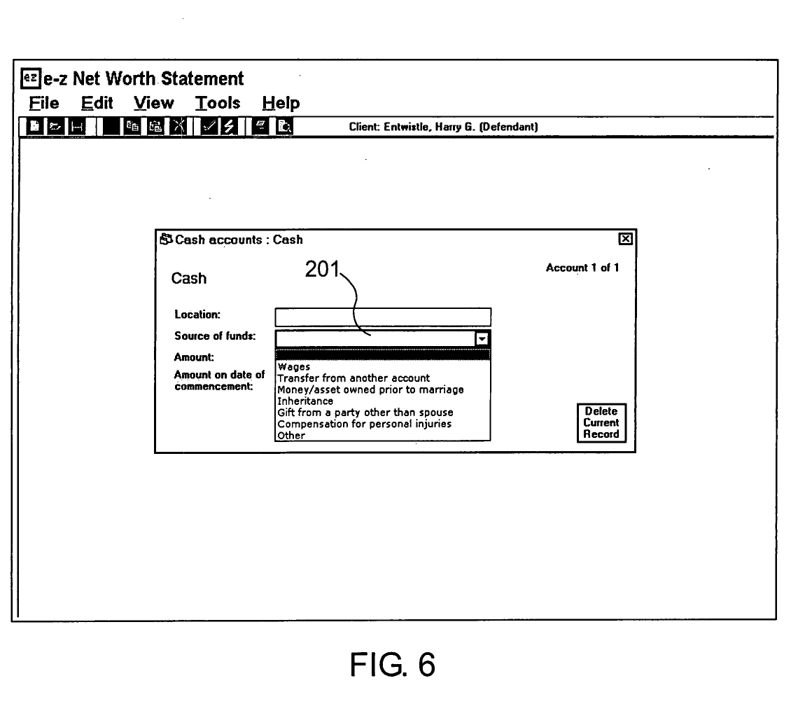

FIG. 6 shows source of funds for a cash or other account 201—available choices include the following texts:

“Wages”

“Transfer from another account”

“Money/asset owned prior to marriage”

“Inheritance”

“Gift from a party other than spouse”

“Compensation for personal injuries”

“Other”

Type of account for a savings account—available choices include the following texts:

“Individual”

“Joint”

“Totten trust”

“Certificate of deposit”

“Treasury notes”

“Other”

Type of deposit for a real estate account—available choices include the following texts:

“Security deposit”

“Earnest money”

“Other”

Type of business for a value of interest in a business—available choices include the following texts:

“DBA”

“Independent Contractor”

“Sole Proprietorship”

“Partnership”

“C-Corporation”

“S-Corporation”

“Other”

Method of valuation for a value of interest in a business—available choices include the following texts:

“Book Value”

“Adjusted Book Value”

“Income Capitalization”

“Discounted Earnings”

“Discounted Cash Flow”

“Price Earnings Multiple”

“Dividend Capitalization”

“Sales Multiple”

“Profit Multiple”

“Liquidation Value”

“Replacement Value”

“True Value”

“Other”

Type of policy for a cash surrender value of insurance—available choices include the following texts:

“Term life”

“Convertible Term life”

“Universal life”

“Whole life”

“Single Premium Policy”

“Second to Die”

“Variable life”

“Annuity”

“Other”

Type of trust for a retirement asset—available choices include the following texts:

“401k”, “403b”, “408k”, “457 plan”, “Individual Retirement Account (IRA)”, “Roth IRA”, “Keogh plan”, “Self-Employed Pension(SEP)”, “Pension Plan”, “Registered Retirement Savings Plan”, “Savings Incentive Match Plan (SIMPLE)”, “Single Premium Deferred Annuity”, “Top hat plan”, “Variable Annuity”, “Other”

Reason for payment for support requirements—available choices include the following texts:

“Voluntarily”

“Pursuant to court order or judgment”

“Pursuant to separation agreement”

Calculation of Net Worth (Point 7)

The invention tracks and subtotals all dollar values entered in all categories and subcategories of worth, accumulating the values in all categories into a summary statement of total assets, total liabilities, and net worth. A change to a dollar value in any subcategory yields an immediate change in the resulting totals.

Validation of Data Values (Point 8)

The invention compares newly-entered information to the information already entered in certain areas, and queries the user to verify the input if the newly-entered information appears inconsistent with what has already been entered.

A primary example of this type of comparison is the invention's validation of recent income against the previous year's W-2 value for income—if there is a difference between the two values exceeding five percent, the invention asks the user for verification of the income values.

A second example of validation occurs during the attempted reduction of a count value for a number of entities in a client's database, such as the count of children. If a client has reported three children, and then the user of the invention tries to change the number of children from three to two, the invention prompts the user to select the particular child to be deleted.

Simplification of Input Process (Point 9)

The invention simplifies the user's task of entering and checking data by reapplying retained information rather than by requesting a second input of the information.

An example of the invention's retention and reapplication of data appears in the retention of self-employment information for the plaintiff and the defendant. At the stage when self-employment information is to be gathered, he invention prompts the user for the number of each of the following categories of self-employment information: the numbers of sole proprietorships, partnerships, independent contractorships, subchapter S corporations, subchapter C corporations, and miscellaneous businesses. After prompting for the number in each of the categories of self-employment information, the invention prompts for the business name, the date of establishment, and the business address for each category of self-employment information.

The invention reuses the self-employment information when it prompts the user to enter income information. When the invention prompts the user to enter income information, it presents to the user exactly the number of screens in each category that were specified by the user in the entry of self-employment information. The user at the stage of entering income information may only change the number of each entries in a given category by returning to the employment information screens and making the changes before proceeding. When the user makes such changes, the invention accordingly changes the number of screens presented for the entry of income information for each self-employment category.

Program Flow and Operation

The invention's program is driven by the choices of the user from those the program presents via its menus and button selections on the screen. The invention's program's displays are defined in terms of the related information to be presented on a single screen. Consequently the program's components correspond to specific screens of information and specific database components. Since a user may select any screen to follow any other screen, an overall flow of operation for the invention's program is therefore not an appropriate way to present the program's workings intelligibly. Even so, the flowchart is a natural and intuitive mode of presentation for most readers.

Given these considerations, the description of the program's flow of operation is here broken down into components which operate within the scope of a given screen display. Where a component's processing is representative of the processing done for multiple components, only a single component is presented here.

In general, the passing of program operation from screen to screen is based not on a strict flow, but on the presence or absence of data in each category. For example, if a party is unemployed, the program will display the nearest relevant category in line, not a category for which no data entry is required. This is a feature of the invention.

The user wishing to follow a simple path to gather and process all required data values will select the ‘Continue’ button on all screens. The resulting order of presentation of combinations of data elements is listed below in the section titled The Invention's Sequence of Presentation and Complete Data Groupings. The sections immediately following this one describe unique program operation and flow characteristics of selected sections of the program.

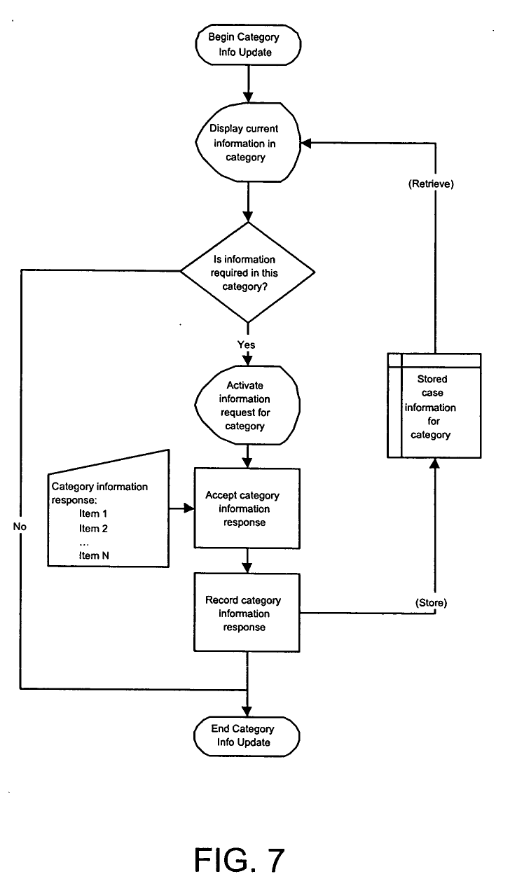

Two flowcharts are included for commonly-used processes. The first, shown in FIG. 7, is called Category Info Update, and comprises a series of steps for displaying a screen with form entry spaces filled in with current information from the client database, soliciting information for the category if needed, accepting the user's input, and recording the user's input in the database.

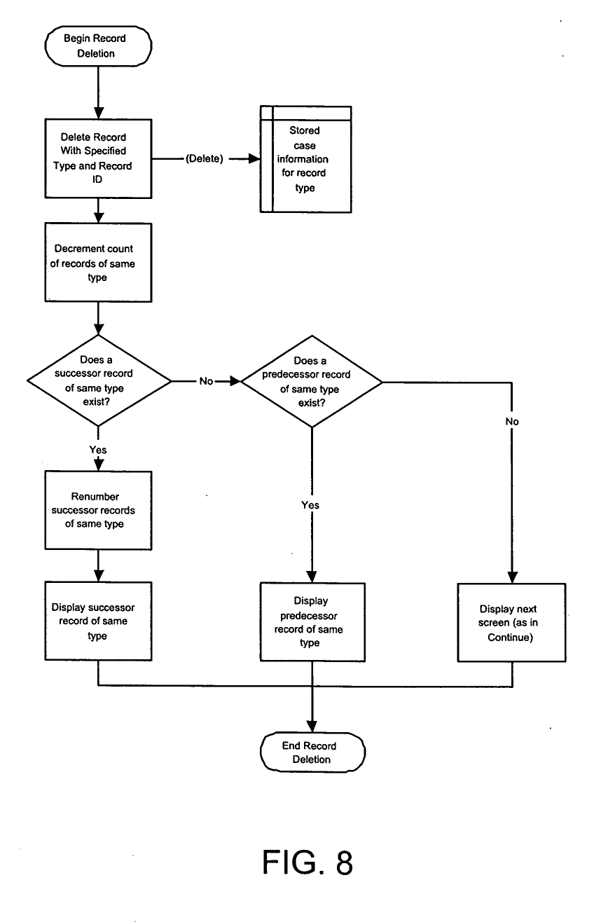

The second, shown in FIG. 8, is called Record Deletion, and comprises a series of steps for deleting a database record of a specified type and record ID, decrementing the count of records of the same type if such a count exists, renumbering any successor records if any exist, displaying the successor record if it exists, displaying any predecessor record if no successor exists, and displaying the next screen in the normal sequence if no predecessor record exists.

Uses of both of these processes are shown in the flowcharts for other processes identified below.

The Program's Navigation Bar

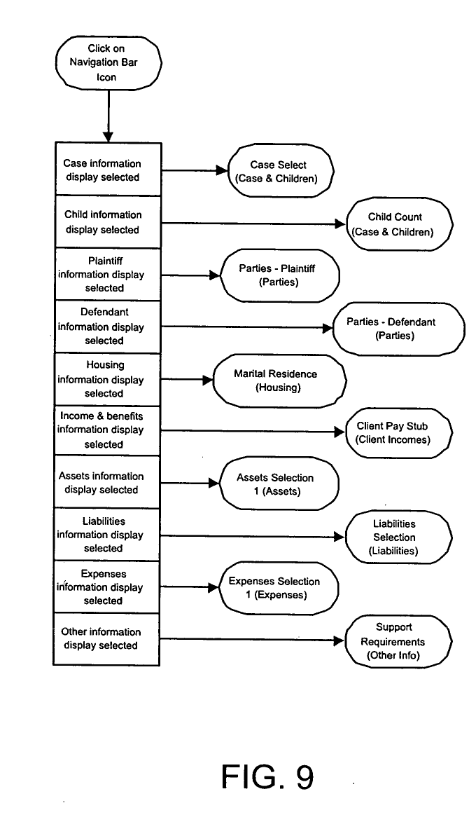

The program's navigation bar usage is shown in FIG. 9. When the user clicks on the navigation bar icon as shown in FIG. 2, the invention displays the navigation bar on the screen as in FIG. 3. The user then selects an entry on the navigation bar, and the program displays the initial screen associated with the selected entry. In some displays, such as the Assets, Liabilities, or Expenses selections, the invention presents the user with a menu of choices within the selected section. In the remaining displays, the invention presents the user with the first of the series of information screens in the selected section.

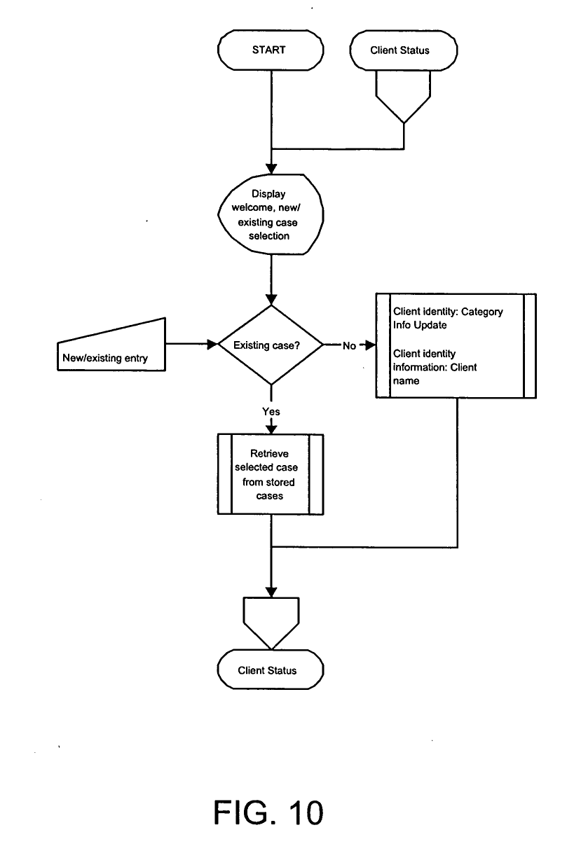

When the program is first started, the program displays a welcome screen and requests user input to determine which case is to be entered or processed. The flow of processing is shown in FIG. 10. When the user creates a new case, the invention constructs a new section of its database to contain the new client's information. When the user selects an existing case, the invention accesses the section of its database reserved for the selected existing case.

Program Flow and Operation for Plaintiff and Defendant Information

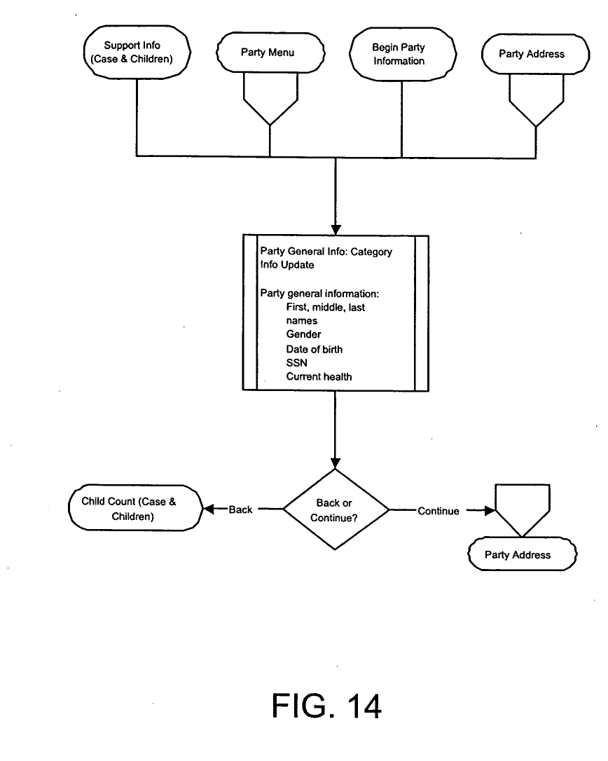

When operating on information which is identical for both parties, the program uses the same displays and responses for both plaintiff and defendant information, but processes plaintiff information first when operated in its normal sequence by continuing from the processing of child information. See FIG. 14. When information on children in common has been processed and the user selects the ‘Continue’ button, the program begins the processing of plaintiff information directly, by prompting the user for general information on the plaintiff.

When the user selects the invention's navigation bar (FIG. 9) and then selects either “Plaintiff” or “Defendant” from the navigation bar, the program begins the processing of information for the party selected from the navigation bar. The specific data elements available to be presented and processed are the same for both parties.

Program Flow and Operation for Marital Residence Information

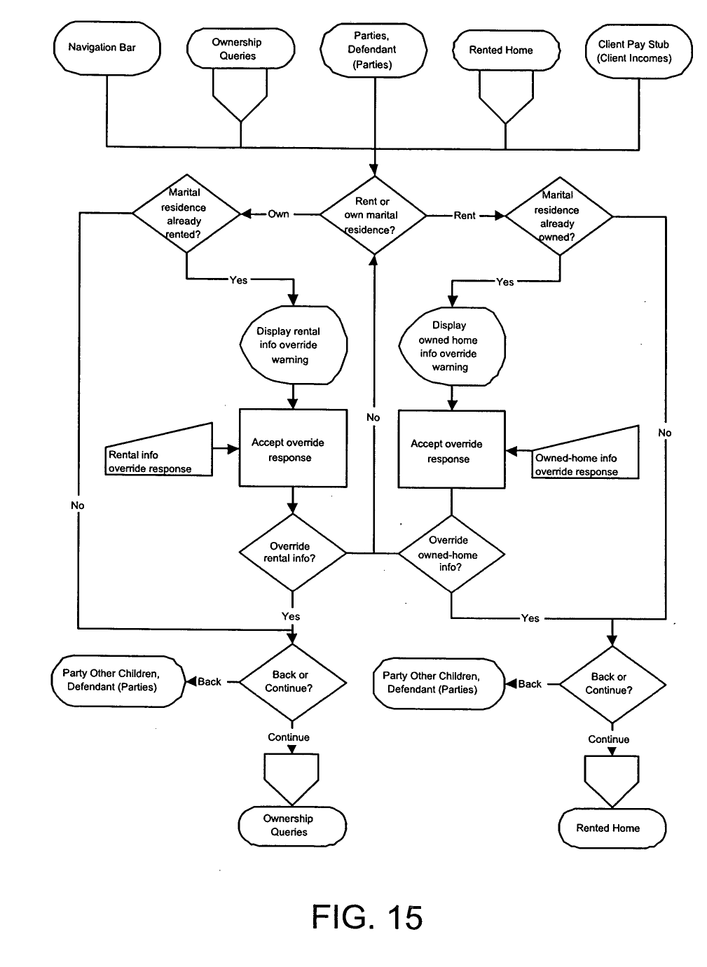

The marital residence may be either owned or rented. The invention's program provides a check when the user attempts to change the status of residence from rented to owned or from owned to rented. See FIG. 15. If the user attempts to change the marital residence status in a case from rented to owned, or from owned to rented, the program warns the user with a displayed message and asks for confirmation of the overriding change. If the user confirms the change, the program deletes the earlier information in the overridden status, and begins prompting the user for information in the overriding status.

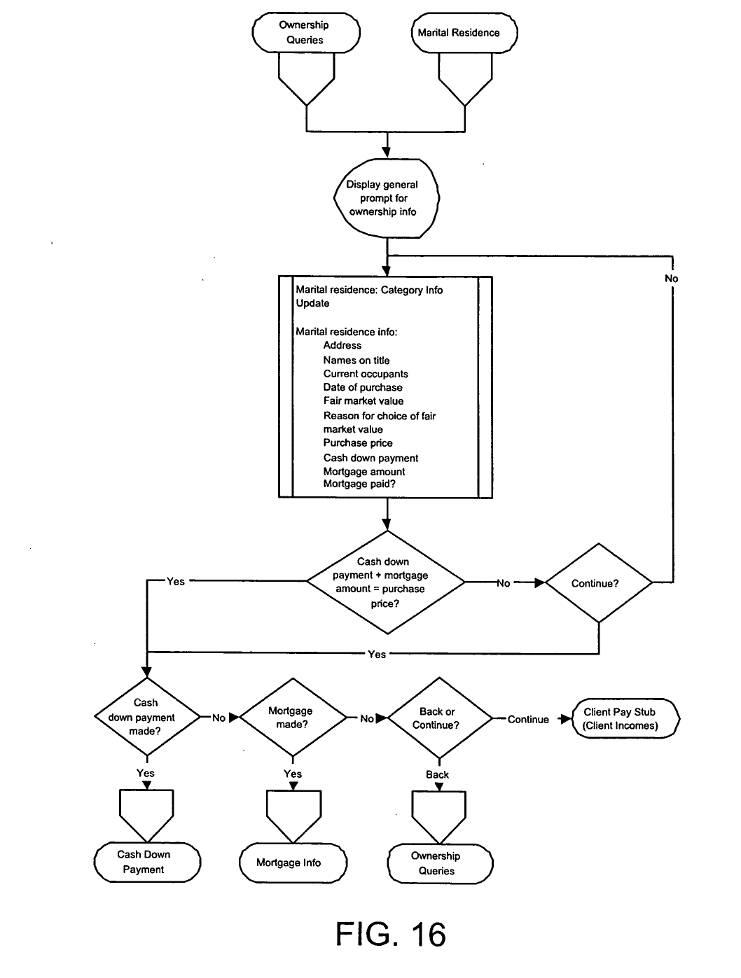

For the Statement of Net Worth, the information required for an owned marital residence is exceptionally detailed. The invention's program begins gathering owned-home information by presenting the user with a query asking whether the user is ready to answer queries requiring the use of the closing statement on the marital residence, the appraisal on the marital residence, the marital residence mortgage statement, and the marital residence real property tax bills. If the user selects the ‘Continue’ button, the program prompts for basic marital residence information (FIG. 16), and then compares the sum of the cash down payment and the mortgage amount against the purchase price. If the comparison fails, the program asks the user for confirmation to continue.

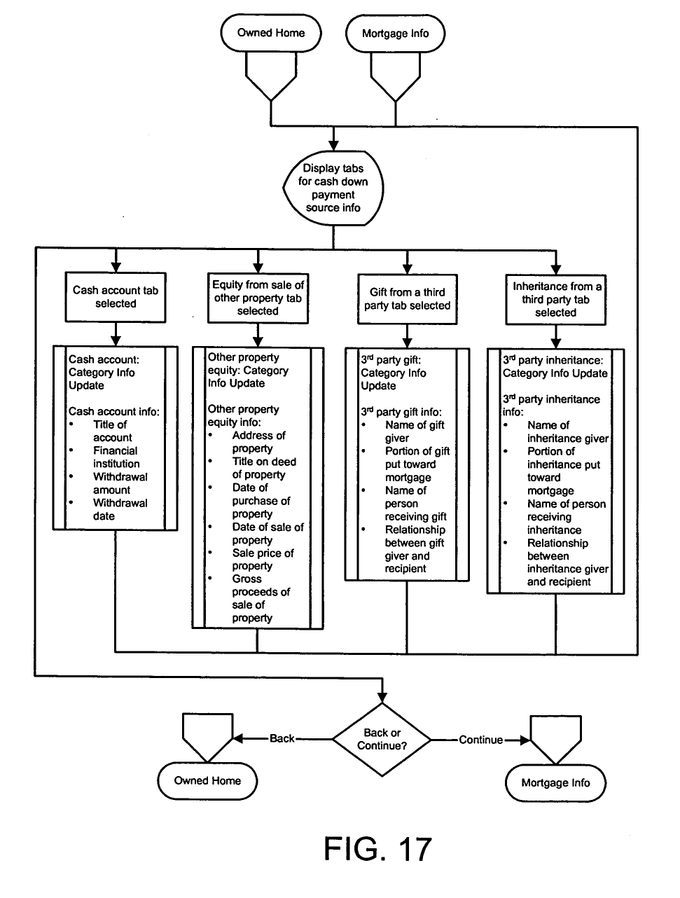

If the user indicates a cash down payment, the program prompts for required details in four categories. See FIG. 17. The cash down payment may originate from a cash account, from the equity from sale of other property, from a gift from a third party, or from an inheritance from a third party. Each category requires the entry of values for a different set of data elements.

If the user indicates a mortgage, the program prompts for required mortgage information on three screens: one for basic mortgage information, one for tax payments included in the mortgage payment, and one for insurance payments included in the mortgage payment.

If the marital residence is rented, the invention's program presents a simple series of screens to the user for gathering rental, insurance, and security information.

Program Flow and Operation for Client Income and Benefits

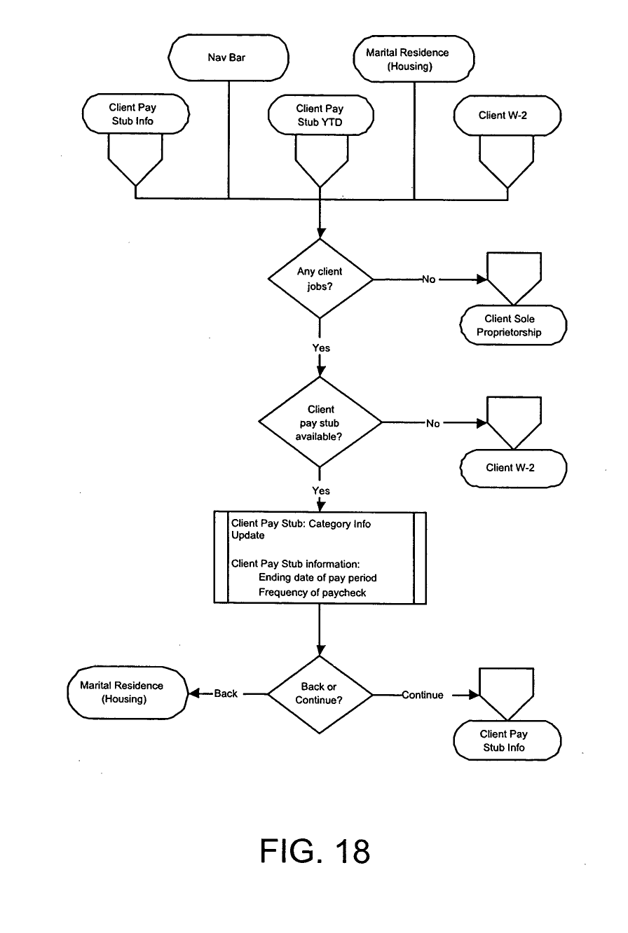

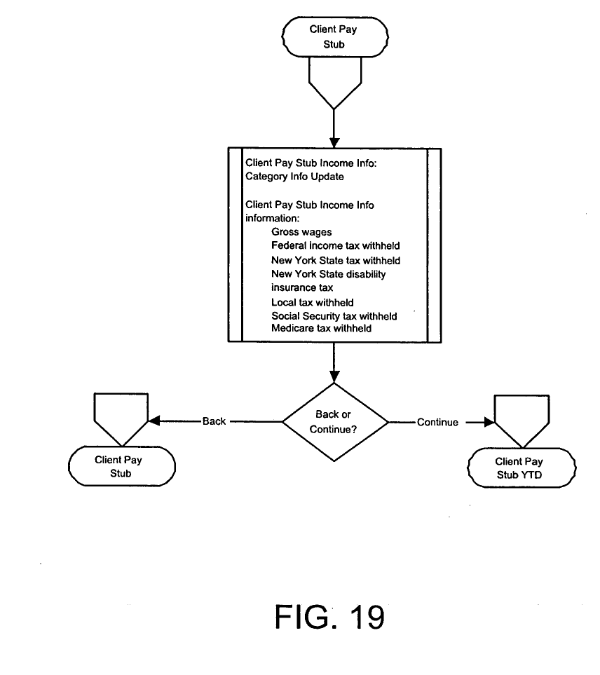

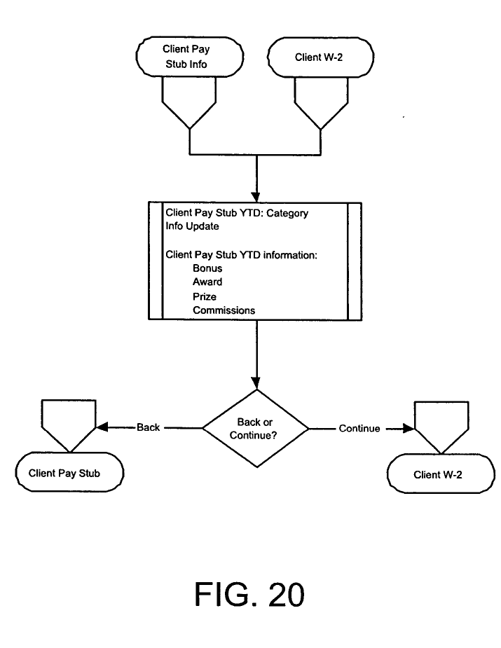

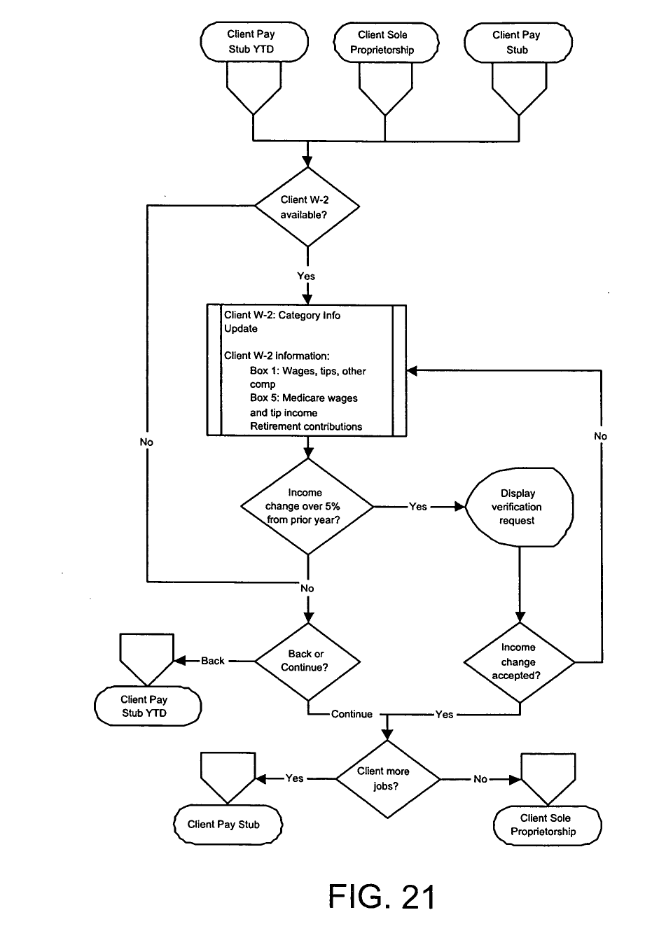

The invention's program requests information on all sources of client income and benefits, beginning with the client's jobs. See FIG. 18. The client may be either the plaintiff or the defendant in the case. For each job as counted earlier in the appropriate party's employment information, the program requests client pay stub information (FIG. 19), client pay stub year-to-date information (FIG. 20), and client W-2 information (FIG. 21). If both pay stub and W-2 information are supplied, the program compares the income reported from the pay stub with the information reported on the W-2, and if the difference of income between current year and prior year exceeds five percent, asks the user to confirm the entries.

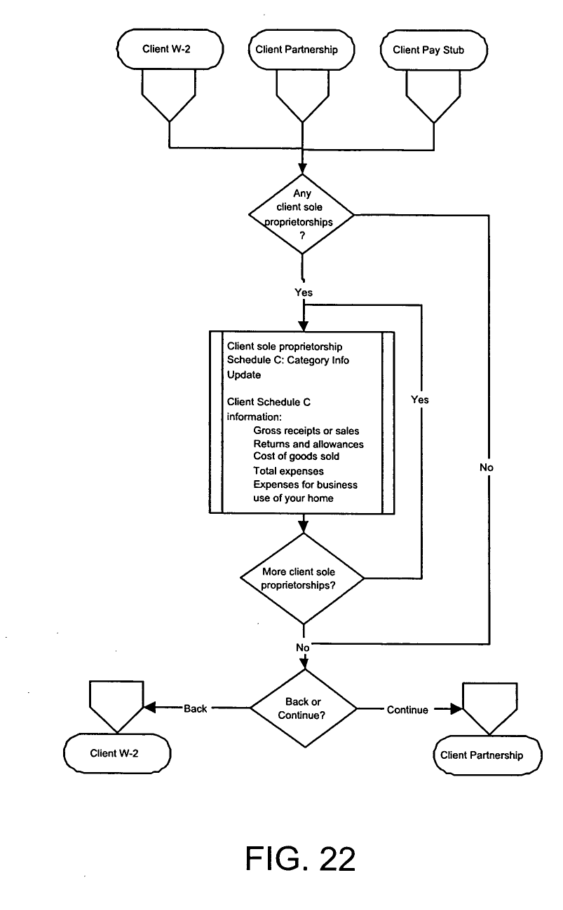

Using the appropriate party's self-employment information entered earlier, the program prompts for client income from sources of self-employment: sole proprietorships, partnerships, contractorships, subchapter-S corporations, subchapter-C corporations, and miscellaneous businesses. FIG. 22 shows the program flow for the sole proprietorship for client income. The program flow for other sources differ only in the data elements presented and processed.

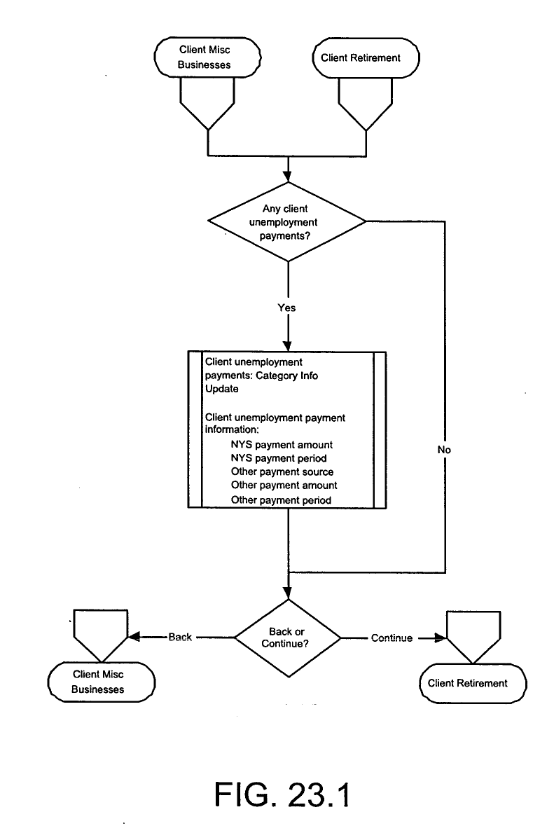

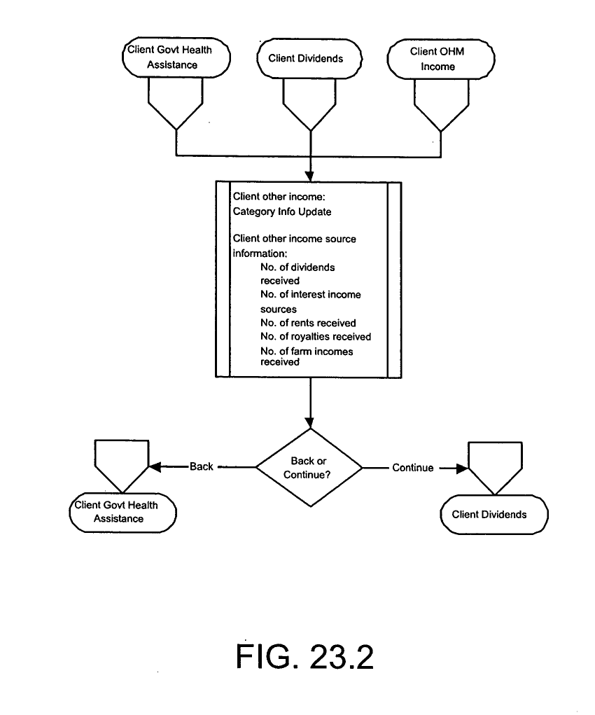

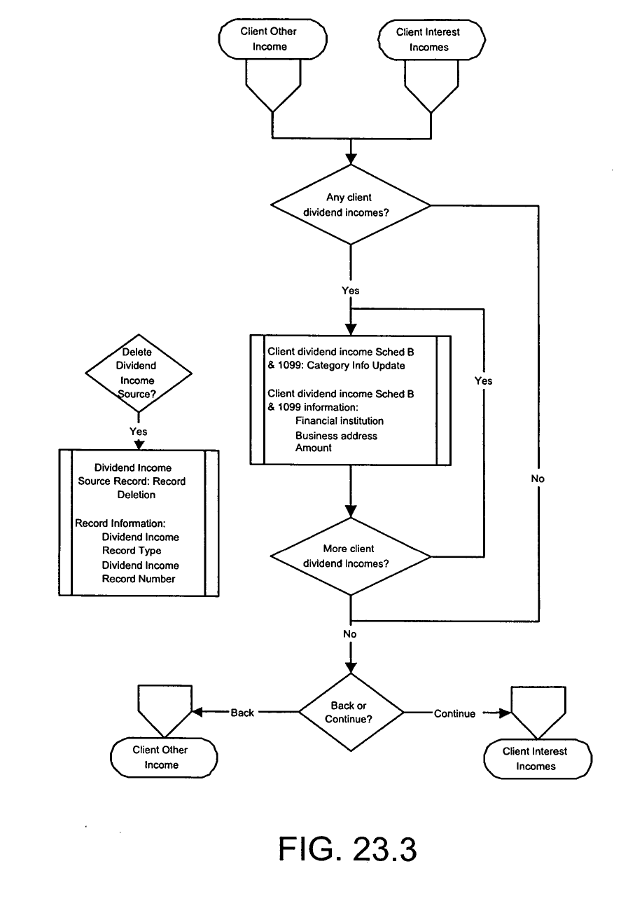

Using the appropriate party's self-employment information entered earlier, the program prompts for client income from unemployment, retirement, or disability income sources. FIG. 23.1 shows the program flow for unemployment payment entry. The program flow for other sources differ only in the data elements presented and processed.

For the client's other income sources, see FIGS. 23.2 and 23.3. First the program requests the number of occurrences of each type of other income source (FIG. 23.2), and then prompts the user for input for each occurrence of each of five types of other income source: dividends received, interest income, rents received, royalties received, and farm incomes received. FIG. 23.3 shows the processing flow for the dividends received type of other income. The other types are handled similarly, with differences only in the data elements displayed and requested.

The processing for the client's other income sources are an example of the processing for all multiple-occurrence types of information.

Program Flow and Operation for Multiple-Occurrence Types of Information

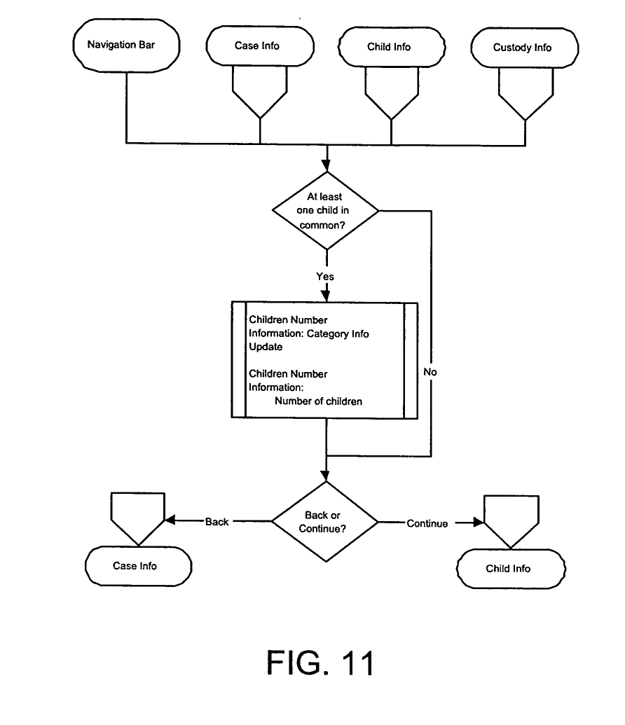

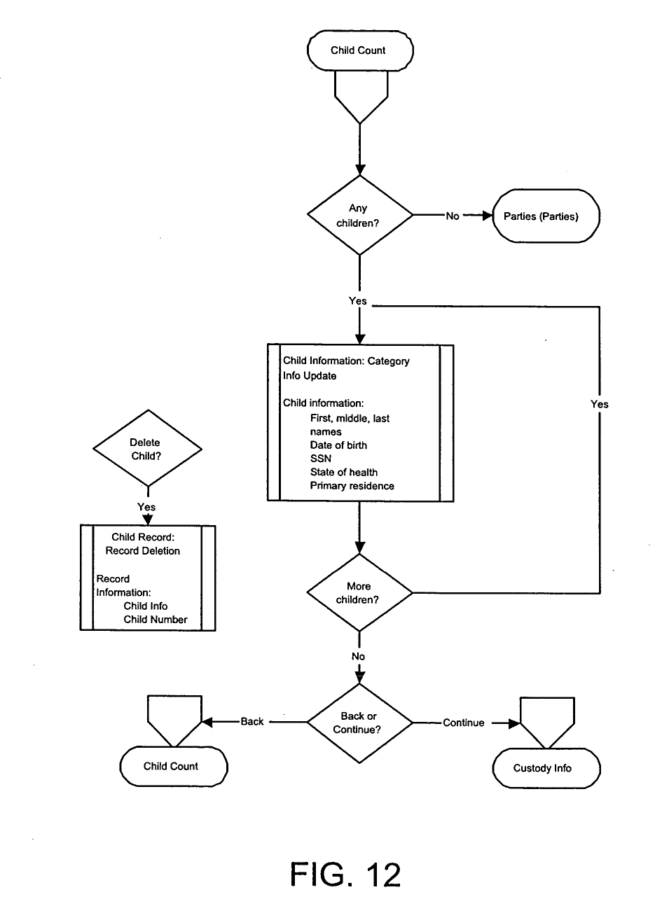

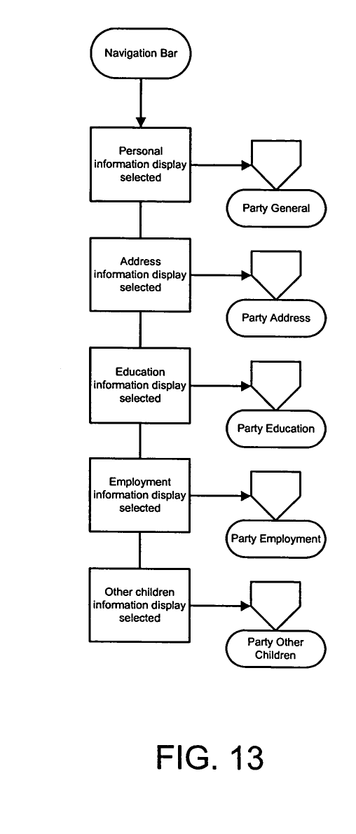

When operating on information in categories where a variable number of occurrences or instances of the information may exist, the invention's program first solicits from the user a count of occurrences, and then stores the provided count of occurrences to define the number of times it requests information in that category. See FIGS. 11 and 12 for an example. If a couple has children in common, the invention asks first for the number of children. On continuing, if the user then continues by selecting the Continue button [xxx] on the screen, the program displays a form for entering identity and health information for one child. When information for one child is entered and the user selects the Continue button [xxx] on the screen, the program stores the information for the one child in a record in its client database, and again displays the form for entering identity and health information, for the next child. When the user has entered information for all children as specified in the count of occurrences earlier, the user's selection of the Continue button causes the program to display a screen for custody information for the children in common.

The user may use the Back button [xxx] on the display to display the identity and health information screen for a previous child. The user may also use the Delete Child button [xxx] on the display to delete a child record from the database. When a Delete operation is requested, the program asks the user to verify that it is to be done.

The program flow in FIGS. 11 and 12 is the same as for other multiple-occurrence types of information. Such multiple-occurrence processing is performed for the following categories of information:

Children in common

Overall education for either party

Jobs for either party

Self-employment situations for either party

Children in common with someone other than the party's spouse

Support orders for children with other parents for the party

Liens on the marital residence apart from the usual mortgage

Client's other income sources

Assets

Liabilities

Expenses for real estate

In all of the above-listed categories of information, the user may also use the Delete button provided on the display to delete an occurrence's record from the database. When a Delete operation is requested, the program asks the user to verify that it is to be done.

For overall education for either party, the program requests the number of each type of diploma or degree, and then prompts the user for input for each occurrence of each type of diploma or degree.

For jobs for either party, the program requests the number of jobs, and then prompts the user for input for each job.

For self-employment situations for either party, the program requests the number of each type of self-employment situation, and then prompts the user for input for each occurrence of each type of self-employment situation. The processing patterns for a sole proprietorship, a partnership, a contractorship, a subchapter-S corporation, a subchapter-C corporation, and a miscellaneous business are the same, although the data elements presented and entered are different. The program retains the number of each type of self-employment situation for later use in prompting for incomes.

For children in common with someone other than the party's spouse, the program requests the number of children the party has in common with someone other than the spouse, and then prompts the user for input for each occurrence of such children.

For support orders for children with other parents for the party, the program requests the number of other parents, and then prompts the user for the child support information related to each parent occurrence.

For liens on the marital residence apart from the usual mortgage, the program requests the number of occurrences of each type of lien, and then prompts the user for input for each occurrence of each of four types of lien: second mortgages, home equity credit lines, mechanic's liens, and other liens. All lien types are handled similarly, with differences only in the data elements displayed and requested.

For the client's other income sources, the program requests the number of occurrences of each type of other income source, and then prompts the user for input for each of five type of other income source: dividends received, interest income received, rents received, royalties received, and farm income received. All other income sources are handled similarly, with differences only in the data elements displayed and requested.

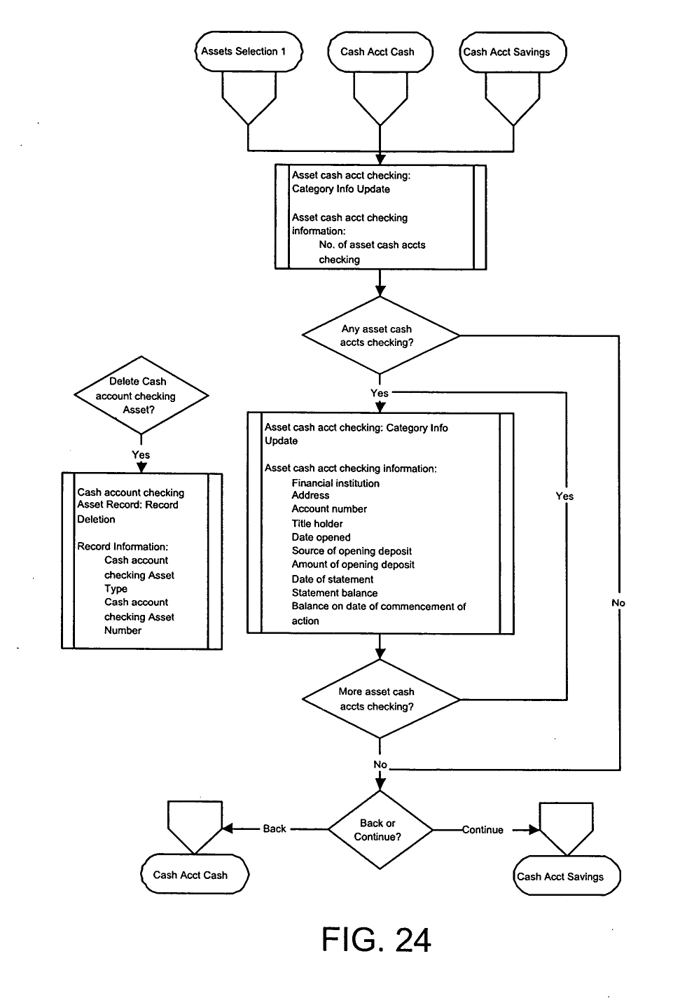

For assets, see FIG. 24 for a typical example. As described for other multiple-occurrence types of information, the program requests the number of occurrences of each type of asset, and then prompts the user for input for each occurrence of each type of asset. The same processing is performed for each type of liability, for each occurrence.

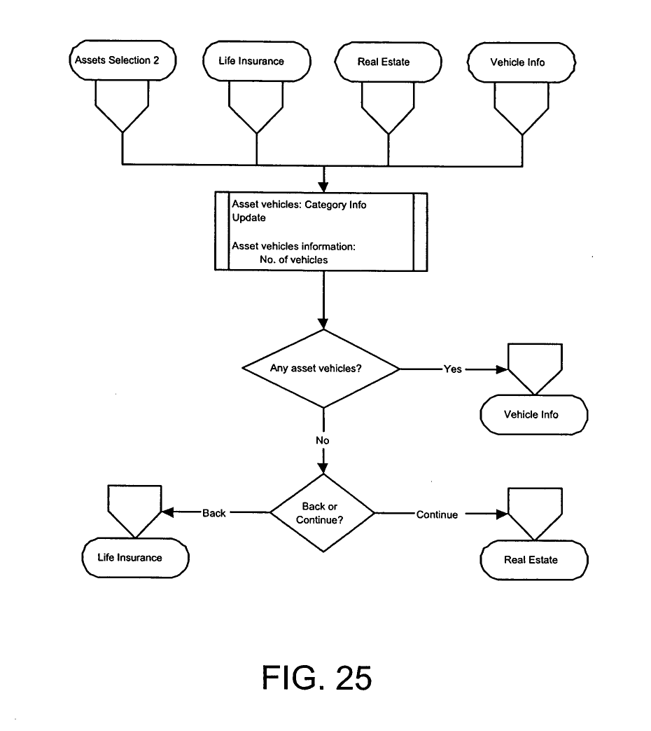

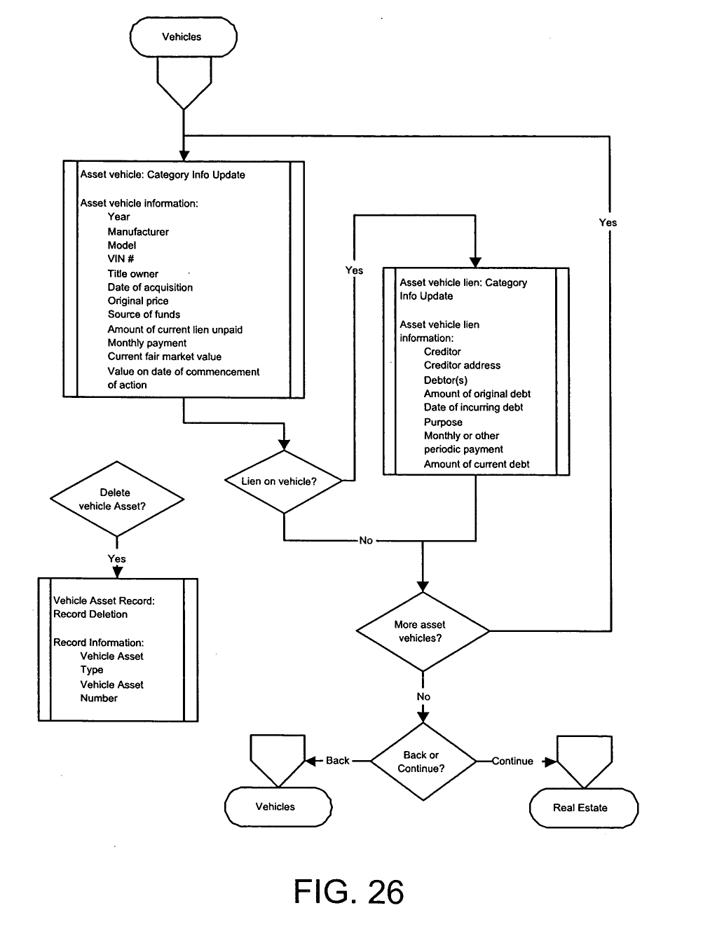

Two types of asset have additional processing performed. For asset vehicles, see FIGS. 25 and 26. The program requests the number of asset vehicles. If there are none, the selection of the ‘Back’ button takes the user to the screen for life insurance assets, and the selection of the ‘Continue’ button takes the user to the screen for real estate assets. If there are asset vehicles, the program prompts the user for input for each vehicle, including any liens on the vehicle.

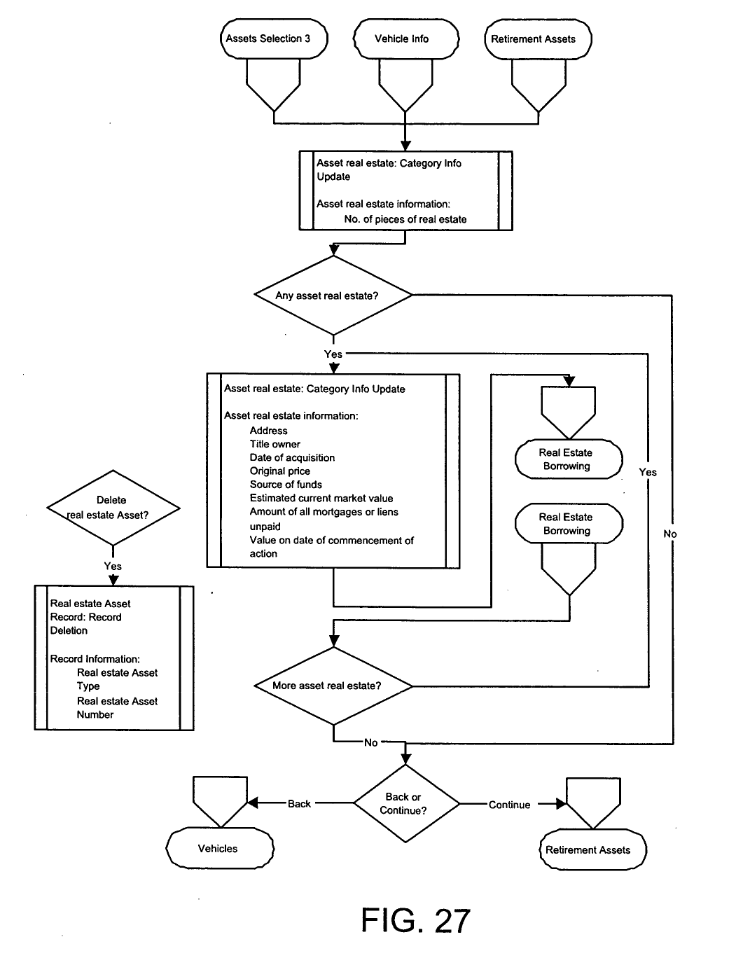

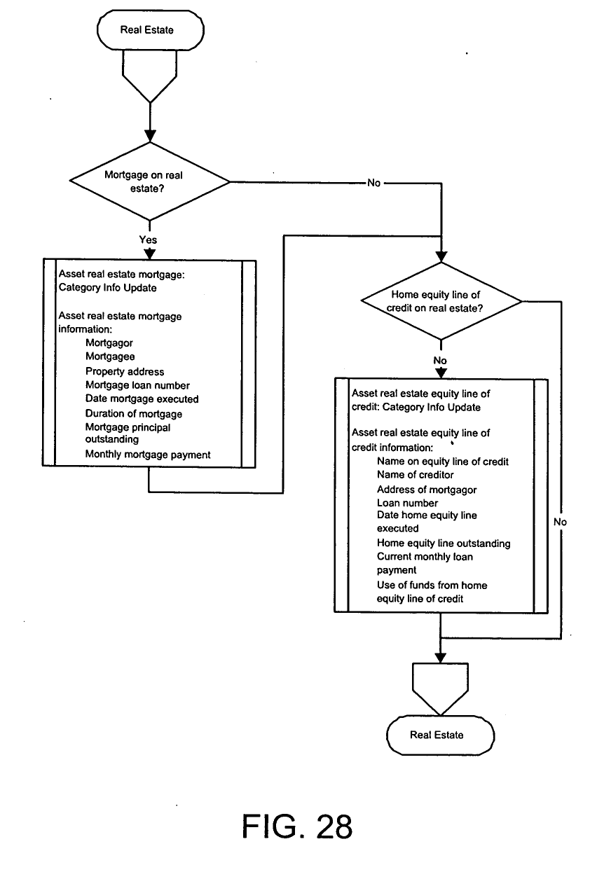

For real estate assets, see FIGS. 27 and 28. The program requests the number of real estate assets. If any real estate assets exist, the program then prompts the user for input for each real estate asset, including mortgages and home equity lines of credit if they exist.

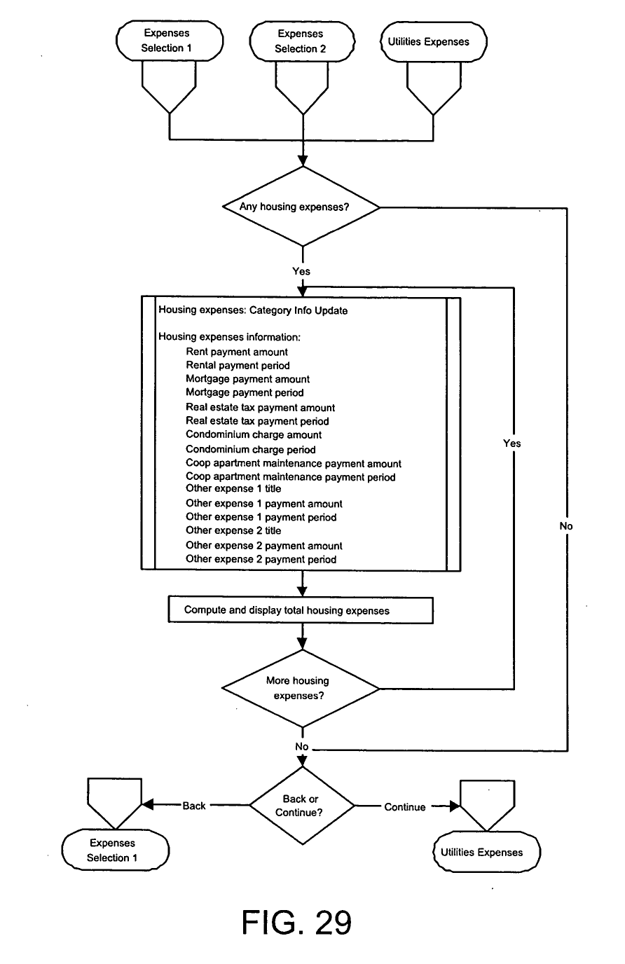

For housing expenses, see FIG. 29. The program applies the user's input of the number of real estate assets as the number of pieces of real estate for which expenses must be entered, and then prompts the user for expense input for each occurrence.

Note that the invention's program maintains running totals of all dollar values in each category to be reported.

Program Flow and Operation for Other Information Categories

In general, and wherever not noted above, the program processes assets, liabilities, expenses, and other information simply by presenting a screen for the user to enter values for data elements and to indicate whether to advance to the next screen using the ‘Continue’ button or move back to the previous screen using the ‘Back’ button.

The Invention's Sequence of Presentation and Complete Data Groupings

The invention stores, maintains, retrieves and reports on all instances of data elements required for the New York State's Statement of Net Worth. The invention sequences its acquisition of said instances as listed below in this section. When using the invention, the user advances through the list in this section by selecting the ‘Continue’ button on the screen. This list's sequence is the natural flow of the program's operation as followed by a typical user.

Since this list includes mention of every category of information and all data elements in each category, it is long. The information categories in this section are:

Case Information

Child Information

Plaintiff Information and Defendant Information (listed under Party Information, since both are identical)

Housing information

Income and Benefits Information

Assets, Liabilities

Expenses

Other Information

Case Information

The invention's case information comprises the following data elements. Case information serves to identify all remaining data elements for the case in the invention's database.

Client identity information:
Client name

Client status information:
plaintiff or defendant

Case information:
County
Index Number
Date of Commencement of Divorce Action

Marriage information:
Date married
Marriage status
Date separated or divorced
   Child Information

The invention's child information comprises the following data elements. Child information serves to identify all children shared by the couple, together with all support and custody information concerning those children.

Children Number Information:
Number of children

For each child: Child information:
First, middle, last names
Date of birth
SSN
State of health
Primary residence

Custody information:
Basic custody order

Support information:
Payor
Basic support amount
Payment frequency
Medical insurance
Dental insurance
Uninsured medical expenses
Day care
Education costs
Amount due
   Party Information

Party information data elements are the same for the plaintiff and the defendant. Party information serves to identify each party and record each party's education, skills, jobs, other income sources, disabilities, other children, and support and custody requirements for other children. The invention provides a menu for rapid access to specific components of information for each party. The invention's information for each party comprises the following data elements.

Party Identity:
Plaintiff or Defendant

Party general information:
First, middle, last names
Gender
Date of birth
SSN
Current health

Party address information:
Street
City
State
Zip code
Country

Party education information (checklist and counts):
No. of high school diplomas
No. of associate's degrees
No. of undergraduate degrees
No. of graduate degrees
No. of doctorate degrees
For each diploma or degree: Degree/diploma information:
   Name of school
   Type of degree
   Graduation year

Party skills information:
Explanation

Party employment status information (checklist):
Employed
Self-employed
Unemployed
Retired
Disabled

Party Jobs
Number of Jobs
For each job: Job information:
   Date of hire
   Work title
   Company name
   Company address

Party self-employment information:
No. of sole proprietorships
No. of partnerships
No. of independent contractorships
No. of S-corporations
No. of C-corporations
No. of miscellaneous businesses
For each sole proprietorship: Sole proprietorship information:
   Business name
   Date of legal establishment
   Business address
For each partnership: Partnership information:
   Business name
   Date of legal establishment
   Business address
For each contractorship: Contractorship information:
   Business name
   Date of legal establishment
   Business address
For each S-corporation: S-corporation information:
   Business name
   Date of legal establishment
   Business address
For each C-corporation: C-corporation information:
   Business name
   Date of legal establishment
   Business address
For each miscellaneous business: Miscellaneous business information:
   Business name
   Date of legal establishment
   Business address

Party most recent employer information:
Date of most recent employment
Most recent employer
Company address
Work title
Most recent earnings
Pay period

Party unemployment benefits information:
Date of most recent employment
Most recent employer
Company address
Work title
Most recent earnings
Pay period

Party retirement information:
Date of most recent employment
Most recent employer
Company address
Work title
Highest annual earnings

Party disability information:
Nature of disability

Party other children information:
No. of other children
For each other child: Other child information:
   Child full name
   Date of birth
   SSN
   Other parent's name
   Child primary residence

Party support orders information:
No. of other parents
For each other child support order: Other child support information:
   Payor
   Other parent name
   Basic support
   Payment period
   Medical insurance expenses
   Dental insurance expenses
   Uninsured medical expenses
   Day care
   Education costs
   Payment status
   Arrears amount due
      Housing

Housing information serves to identify the marital residence, whether it is rented or owned, all rental terms if rented, and all closing, appraisal, mortgage, and tax information if owned. The invention's housing information comprises the following data elements.

Marital Residence:
Rented or Owned

Marital residence rental info:
Rental address
Description of residence
Monthly rental charge
Written lease signed?
Date lease signed

Marital residence rental security deposit info:
Security deposit amount
Source
Date deposit given

Marital residence tenant insurance info:
Insurance amount
Payment period

Marital Residence Ownership Queries:
Ready or Not

Marital residence info:
Address
Names on title
Current occupants
Date of purchase
Fair market value
Reason for choice of fair market value
Purchase price
Cash down payment
Mortgage amount
Mortgage paid?

Cash account info:
Title of account
Financial institution
Withdrawal amount
Withdrawal date

Other property equity info:
Address of property
Title on deed of property
Date of purchase of property
Date of sale of property
Sale price of property
Gross proceeds of sale of property

3rd party gift info:
Name of gift giver
Portion of gift put toward mortgage
Name of person receiving gift
Relationship between gift giver and recipient

3rd party inheritance info:
Name of inheritance giver
Portion of inheritance put toward mortgage
Name of person receiving inheritance
Relationship between inheritance giver and recipient

Mortgage information:
Name on mortgage
Name of mortgagee
Address of mortgagee
Mortgage loan number
Date mortgage executed
Length of mortgage
Mortgage principal outstanding
Current monthly mortgage payment

Real property tax information (checklist and values):
County name, tax amount, frequency of payment
Town name, tax amount, frequency of payment
City name, tax amount, frequency of payment
School name, tax amount, frequency of payment

Homeowner's insurance information:
Amount of payment
Frequency of payment

Overall other lien information (checklist and counts):
No. of second mortgages
No. of home equity credit lines
No. of mechanic's liens
No. of other liens
For each second mortgage: Second mortgage information:
   Mortgagor(s)
   Mortgagee
   Mortgagee address
   Mortgage loan number
   Date mortgage executed
   Duration of mortgage
   Mortgage principal outstanding
   Monthly mortgage payment
For each home equity line of credit: Home equity line of credit information:
   Name on line of credit
   Creditor
   Creditor address
   Loan number
   Date home equity line of credit executed
   Home equity line amount outstanding
   Current monthly payment
   Use of funds from line of credit
For each mechanic's lien: Mechanic's lien information:
   Contractor
   Contractor address
   Original lien amount
   Balance due
   Date lien secured
   Work performed
   Date work performed
For each other lien: Other lien information:
   Debtor
   Creditor
   Mortgagee address
   Date
   Loan amount
   Payment terms
   Balance outstanding
      Client Income Information

Client income information serves to identify all sources of client income including jobs, self-employment arrangements, unemployment, disability, retirement, government assistance, investment returns, and income from other household members. The invention references relevant tax documents as sources of information for the user. The invention also uses its own earlier counts of jobs, self-employment arrangements, and investments to prompt the user. The invention's client income information comprises the following data elements.

For each client job:
Client Pay Stub information:
Ending date of pay period
Frequency of paycheck
Client Pay Stub Income Info information:
   Gross wages
   Federal income tax withheld
   New York State tax withheld
   New York State disability insurance tax
   Local tax withheld
   Social Security tax withheld
   Medicare tax withheld
Client Pay Stub YTD information:
   Bonus
   Award
   Prize
   Commissions
Client W-2 information:
   Box 1: Wages, tips, other comp
   Box 5: Medicare wages and tip income
   Retirement contributions

For each client sole proprietorship: Client Schedule C information (sole proprietorship):
Gross receipts or sales
Returns and allowances
Cost of goods sold
Total expenses
Expenses for business use of your home

For each client partnership: Client Form 1065 information (partnership):
Gross receipts or sales
Returns or allowances
Cost of goods sold
Total deductions

For each client contractorship: Client independent contractorship information:
Gross receipts or sales
Returns or allowances
Cost of goods sold
Total deductions

For each client S-corporation: Client Form 1120S information (S-corp):
Gross receipts or sales
Returns or allowances
Cost of goods sold
Total deductions

For each client C-corporation: Client Form 1120 information (C-corp):
Gross receipts or sales
Returns or allowances
Cost of goods sold
Total deductions

For each client miscellaneous business: Client miscellaneous businesses information:
Gross receipts or sales
Returns or allowances
Cost of goods sold
Total deductions

Client unemployment payment information:
NYS payment amount
NYS payment period
Other payment source
Other payment amount
Other payment period

Client retirement payment information (checklist and values):
Social Security retirement benefits amount
Social Security retirement benefits payment period
Pension benefits amount
Pension benefits payment period
Retirement account distribution amount
Retirement account distribution payment period
1st other payment source
1st other payment amount
1st other payment period
2nd other payment source
2nd other payment amount
2nd other payment period

Client disability payment information (checklist and values):
Social Security disability insurance amount
Social Security disability insurance payment period
Social Security disability insurance amount (spouse)
Social Security disability insurance payment period (spouse)
Social Security disability insurance amount (children)
Social Security disability insurance payment period (children)
Vets comp & pension benefits amount
Vets comp & pension benefits payment period
Retirement account distribution amount
Retirement account distribution payment period
NYS disability benefits amount
NYS disability benefits payment period
Worker's comp benefits amount
Worker's comp benefits payment period
1st other payment source
1st other payment amount
1st other payment period
2nd other payment source
2nd other payment amount
2nd other payment period

Client government assistance payment information (checklist and values):
Food Stamp Program amount
Food Stamp Program payment period
Supplemental Nutrition Program (WIC) amount
Supplemental Nutrition Program (WIC) payment period
Supplemental Security income amount
Supplemental Security income payment period
National School Lunch Program use
School Breakfast Program use
Summer Food Service Program for Children use
Child and Adult Care Food Program (CACFP) use
Emergency Food Assistance Program (TEFAP) use
Community Food and Nutrition Program (CFNP) use

Client government health assistance payment information (checklist):
Family Health Plus use
Healthy NY use

Client other income source information (checklist and counts):
No. of dividends received
No. of interest income sources
No. of rents received
No. of royalties received
No. of farm incomes received
For each client dividend received: Client dividend income Sched B & 1099 information:
   Financial institution
   Business address
   Amount
For each client interest income received: Client interest income Sched B & 1099 information:
   Financial institution
   Business address
   Amount
For each client rental income received: Client rental income Sched E information:
   Rents received
   Expenses
   Depreciation
For each client royalty income received: Client royalty income Sched E information:
   Royalties received
   Expenses
   Depreciation
For each farm income received: Client farm income Sched F information:
   Gross income
   Expenses

Client other household member income source information (checkbox and count):
No. of employed household members
For each client employed household member: Other household member income information:
   Name
   Annual income
      Assets

Asset information serves to identify all assets belonging to the client, including all types of cash accounts, all types of securities, loans to others and receivables, business ownership and valuation, life insurance, vehicles, real estate, retirement assets, contingent interests, household furnishings, valuables, and other types of asset including intellectual property. The invention provides a menu for rapid access to specific components of asset information. The invention's asset information comprises the following data elements.

Asset cash acct cash information (checkbox and count):
No. of asset cash accts cash
For each cash account: Asset cash acct cash information:
   Location
   Source of funds
   Amount
   Amount on date of commencement

Asset cash acct checking information (checkbox and count):
No. of asset cash accts checking
For each checking account: Asset cash acct checking information:
   Financial institution
   Address
   Account number
   Title holder
   Date opened
   Source of opening deposit
   Amount of opening deposit
   Date of statement
   Statement balance
   Balance on date of commencement of action

Asset cash acct savings information (checkbox and count):
No. of asset cash accts savings
For each savings cash account: Asset cash acct savings information:
   Financial institution
   Address
   Account number
   Title holder
   Type of account
   Date opened
   Source of opening deposit
   Amount of opening deposit
   Date of statement
   Statement balance
   Balance on date of commencement of action

Asset cash acct real estate deposit information (checkbox and count):
No. of asset cash accts real estate deposit
For each real estate cash account: Asset cash acct real estate deposit information:
   Location
   Address
   Title owner
   Type of deposit
   Date of deposit
   Source of deposit
   Current value of deposit
   Value on date of commencement of action

Asset cash acct other information (checkbox and count):
No. of asset cash accts other
For each other cash account: Asset cash acct other information:
   Location
   Address
   Account number
   Title owner
   Type of account
   Date of deposit
   Source of opening deposit
   Current amount
   Amount on date of commencement of action

Asset securities bonds notes information (checkbox and count):
No. of securities bonds notes etc.
For each asset security bond, note, etc.: Asset securities bonds notes information:
   Type of security
   Description of security
   Title holder
   Location
   Date of acquisition
   Maturity date
   Original price
   Source of funds
   Interest rate
   Frequency of interest payment
   Current value
   Value on date of commencement of action

Asset securities stocks options information (checkbox and count):
No. of asset securities stocks options etc.
For each asset security stock option etc.: Asset securities stocks options information:
   Description of security
   Title holder
   Location
   Date of acquisition
   Original price
   Source of funds
   Current value
   Value on date of commencement of action

Asset securities broker margin accts information (checkbox and count):
No. of asset broker margin accts
For each broker margin account: Asset securities broker margin accts information:
   Broker
   Broker address
   Title holder
   Date account opened
   Original value of account
   Source of funds
   Current value
   Value on date of commencement of action

Asset securities other information (checkbox and count):
No. of asset securities other
For each other asset security: Asset securities other information:
   Broker
   Broker address
   Account number
   Description of security
   Title holder
   Date account opened
   Original value of account
   Source of funds
   Current value
   Value on date of commencement of action

Asset loans accts receivable information (checkbox and count):
No. of loans accts receivable
For each loan account receivable: Asset loans accts receivable information:
   Debtor
   Debtor address
   Creditor
   Original amount obligation
   Duration of loan
   Source of funds
   Date payment due
   Current amount due
   Amount due on date of commencement of action

Asset business ownership and value information (checkbox and count):
No. of business ownerships and valuations
For each business ownership and valuation: Asset business ownership and value information:
   Name of business
   Business address
   Type of business
   Ownership interest
   Date of acquisition
   Cost to acquire ownership interest
   Source of funds
   Value of business
   Method of valuation
   Date of valuation
   Valuation on date of commencement of action

Asset life insurance information (checkbox and count):
No. of life insurance policies
For each life insurance policy: Asset life insurance information:
   Insurance company
   Insurer's address
   Name of insured
   Policy owner
   Policy number
   Death benefit
   Type of policy
   Date of acquisition
   Source of funds
   Current cash surrender value
   Value on date of commencement of action

Asset vehicles information (checkbox and count):
No. of vehicles
For each vehicle: Asset vehicle information:
   Year
   Manufacturer
   Model
   VIN#
   Title owner
   Date of acquisition
   Original price
   Source of funds
   Amount of current lien unpaid
   Monthly payment
   Current fair market value
   Value on date of commencement of action
   Asset vehicle lien information:
      Creditor
      Creditor address
      Debtor(s)
      Amount of original debt
      Date of incurring debt
      Purpose
      Monthly or other periodic payment
      Amount of current debt

Asset real estate information (checkbox and count):
No. of pieces of real estate
For each piece of real estate: Asset real estate information:
   Address
   Title owner
   Date of acquisition
   Original price
   Source of funds
   Estimated current market value
   Amount of all mortgages or liens unpaid
   Value on date of commencement of action
   Asset real estate mortgage information:
      Mortgagor
      Mortgagee
      Property address
      Mortgage loan number
      Date mortgage executed
      Duration of mortgage
      Mortgage principal outstanding
      Monthly mortgage payment
   Asset real estate equity line of credit information:
      Name on equity line of credit
      Name of creditor
      Address of mortgagor
      Loan number
      Date home equity line executed
      Home equity line outstanding
      Current monthly loan payment
      Use of funds from home equity line of credit

Asset retirement assets information (checkbox and count):
No. of retirement assets
For each retirement asset: Asset retirement asset information:
   Type of trust
   Financial institution
   Address
   Account number
   Title owner
   Date of acquisition
   Original investment
   Source of funds
   Amount of unpaid liens
   Gross (pre-tax) value
   Value on date of commencement of action

Asset contingent interests information (checkbox and count):
No. of contingent interests
For each asset contingent interest: Asset contingent interest information:
   Description
   Location
   Date of vesting
   Title owner
   Date of acquisition
   Original price or value
   Source of funds
   Method of valuation
   Current value
   Value on date of commencement of action

Asset household furnishings information (checkbox and count):
No. of household furnishings
For each asset household furnishing: Asset household furnishings information:
   Description
   Location
   Title owner
   Original price or value
   Source of funds
   Amount of lien unpaid
   Current value
   Value on date of commencement of action

Asset valuables information (checkbox and count):
No. of asset valuables
For each asset valuable: Asset valuables information:
   Description
   Location
   Title owner
   Original price or value
   Source of funds
   Amount of lien unpaid
   Current value
   Value on date of commencement of action

Asset other assets information (checkbox and count):
No. of other assets
For each other asset: Asset other asset information:
   Description
   Location
   Title owner
   Original price or value
   Source of funds
   Amount of lien unpaid
   Current value
   Value on date of commencement of action
      Liabilities

Liability information serves to identify all liabilities belonging to the client, including accounts, notes, and installment accounts payable, brokers' margin accounts, mortgages payable, taxes payable, loans on life insurance policies, and other types of liability. The invention provides a menu for rapid access to specific components of liability information. The invention's liability information comprises the following data elements.

Liability accts payable information (checkbox and count):
No. of liability accts payable
For each liability account payable: Liability accts payable information:
   Creditor
   Creditor address
   Debtor
   Account number
   Amount of original debt
   Date of incurring debt
   Purpose
   Date of statement
   Monthly or other periodic payment
   Amount of current debt
   Amount on date of commencement of action

Liability notes payable information (checkbox and count):
No. of liability notes payable
For each liability note payable: Notes payable information:
   Creditor
   Creditor address
   Debtor
   Amount of original debt
   Date of incurring debt
   Purpose
   Date of statement
   Monthly or other periodic payment
   Amount of current debt
   Amount on date of commencement of action

Liability installment accts payable information (checkbox and count):
No. of liability installment accts payable
For each liability installment account payable: Installment accts payable information:
   Creditor
   Creditor address
   Debtor
   Amount of original debt
   Date of incurring debt
   Purpose
   Date of statement
   Monthly or other periodic payment
   Amount of current debt
   Amount on date of commencement of action

Brokers' margin accts payable information (checkbox and count):
No. of brokers' margin accts payable
For each brokers' margin account payable: Brokers' margin accts payable information:
   Broker
   Broker address
   Amount of original debt
   Date of incurring debt
   Purpose
   Date of statement
   Monthly or other periodic payment
   Current debt
   Amount on date of commencement of action

Mortgages payable information (checkbox and count):
No. of mortgages payable
For each mortgage payable: Mortgages payable information:
   Mortgagee
   Mortgagee address
   Property address
   Mortgagor
   Original debt
   Date of incurring debt
   Monthly or other periodic payment
   Maturity date
   Amount of current debt
   Amount on date of commencement of action

Taxes payable information (checkbox and count):
No. of Taxes payable
For each tax payable: Taxes payable information:
   Description of tax
   Amount of tax
   Date due
   Amount on date of commencement of action

Life insurance loans payable information (checkbox and count):
No. of life insurance loans payable
For each life insurance loan payable: Life insurance loans payable information:
   Insurer
   Insurer address
   Amount of loan
   Date of incurring debt
   Purpose
   Name of borrower
   Date of statement
   Monthly or other periodic payment
   Amount of current debt
   Amount on date of commencement of action

Other liabilities information (checkbox and count):
No. of Other liabilities
For each other liability: Other liability information:
   Creditor
   Creditor address
   Debtor
   Amount of original debt
   Date of incurring debt
   Purpose
   Date of statement
   Monthly or other periodic payment
   Amount of current debt
   Amount on date of commencement of action
      Expenses

Expense information serves to identify all expenses in the case, including real estate, utilities, food, clothing, laundry, insurance, unreimbursed medical, household maintenance, domestic labor, automotive, educational, recreational, miscellaneous, and other types of expense. The invention uses its own earlier count of real estate assets to prompt the user. The invention provides a menu for rapid access to specific components of expense information. The invention's expense information comprises the following data elements.

For each piece of real estate: Housing expenses information:
Rent payment amount
Rental payment period
Mortgage payment amount
Mortgage payment period
Real estate tax payment amount
Real estate tax payment period
Condominium charge amount
Condominium charge period
Coop apartment maintenance payment amount
Coop apartment maintenance payment period
Other expense 1 title
Other expense 1 payment amount
Other expense 1 payment period
Other expense 2 title
Other expense 2 payment amount
Other expense 2 payment period

Utilities expenses information:
Fuel oil payment amount
Fuel oil payment period
Gas payment amount
Gas payment period
Electricity payment amount
Electricity payment period
Water payment amount
Water payment period
Firewood payment amount
Firewood payment period
Propane payment amount
Propane payment period
Trash removal payment amount
Trash removal payment period
Burglar alarm system payment amount
Burglar alarm system payment period
Residential telephone payment amount
Residential telephone payment period
Cellular telephone payment amount
Cellular telephone payment period
Pager payment amount
Pager payment period
Internet service payment amount
Internet service payment period
Other expense 1 title
Other expense 1 payment amount
Other expense 1 payment period
Other expense 2 title
Other expense 2 payment amount
Other expense 2 payment period
Other expense 3 title
Other expense 3 payment amount
Other expense 3 payment period

Food expenses information:
Groceries payment amount
Groceries payment period
School lunches payment amount
School lunches payment period
Lunches at work payment amount
Lunches at work payment period
Dining out payment amount
Dining out payment period
Alcohol payment amount
Alcohol payment period
Other expense 1 title
Other expense 1 payment amount
Other expense 1 payment period
Other expense 2 title
Other expense 2 payment amount
Other expense 2 payment period

Clothing expenses information:
Husband clothing payment amount
Husband clothing payment period
Wife clothing payment amount
Wife clothing payment period
Children clothing payment amount
Children clothing payment payment period
Work uniform payment amount
Work uniform payment period
Other expense 1 title
Other expense 1 payment amount
Other expense 1 payment period
Other expense 2 title
Other expense 2 payment amount
Other expense 2 payment period

Laundry expenses information:
Laundromat payment amount
Laundromat payment period
Dry cleaning payment amount
Dry cleaning payment period
Laundry service payment amount
Laundry service payment period
Other expense 1 title
Other expense 1 payment amount
Other expense 1 payment period
Other expense 2 title
Other expense 2 payment amount
Other expense 2 payment period

Household maintenance expenses information:
Repairs payment amount
Repairs payment period
Furniture, linens, furnishings payment amount
Furniture, linens, furnishings payment period
Cleaning supplies payment amount
Cleaning supplies payment period
Appliances incl. service contracts payment amount
Appliances inc. Service contracts payment period
Painting and wallpapering payment amount
Painting and wallpapering payment period
Lawn and garden payment amount
Lawn and garden payment period
Landscaping payment amount
Landscaping payment period
Snow removal payment amount
Snow removal payment period
Extermination payment amount
Extermination payment period
Remodeling payment amount
Remodeling payment period
Decorating payment amount
Decorating payment period
Other expense 1 title
Other expense 1 payment amount
Other expense 1 payment period
Other expense 2 title
Other expense 2 payment amount
Other expense 2 payment period

Domestic labor expenses information:
Housekeeper payment amount
Housekeeper payment period
Babysitter payment amount
Babysitter payment period
Diaper service payment amount
Diaper service payment period
Errand service payment amount
Errand service payment period
Other expense 1 title
Other expense 1 payment amount
Other expense 1 payment period
Other expense 2 title
Other expense 2 payment amount
Other expense 2 payment period

Automotive expenses information:
Loan payments amount
Loan payments period
Lease payment amount
Lease payment period
Gas and oil payment amount
Gas and oil payment period
Repair service payment amount
Repair service payment period
Parts payment amount
Parts payment period
Car wash payment amount
Car wash payment period
Registration payment amount
Registration payment period
Inspection payment amount
Inspection payment period
License payment amount
License payment period
Parking payment amount
Parking payment period
Tolls payment amount
Tolls payment period
Other expense 1 title
Other expense 1 payment amount
Other expense 1 payment period
Other expense 2 title
Other expense 2 payment amount
Other expense 2 payment period

Education expenses information:
Nursery and pre-school payment amount
Nursery and pre-school payment period
Furniture, linens, furnishings payment amount
Furniture, linens, furnishings payment period
Primary payment amount
Primary payment period
Secondary payment amount
Secondary payment period
Post-secondary payment amount
Post-secondary payment period
Graduate payment amount
Graduate payment period
Daycare payment amount
Daycare period
Religious instruction payment amount
Religious instruction payment period
School transportation payment amount
School transportation payment period
School supplies/books payment amount
School supplies/books payment period
Tutoring payment amount
Tutoring payment period
School events/activities payment amount
School events/activities payment period
Other expense 1 title
Other expense 1 payment amount
Other expense 1 payment period
Other expense 2 title
Other expense 2 payment amount
Other expense 2 payment period

Recreational expenses information:
Summer camp payment amount
Summer camp payment period
Vacation and travel payment amount
Vacation and travel payment period
Movies payment amount
Movies payment period
Books, magazines, newspapers payment amount
Books, magazines, newspapers payment period
Theater, ballet, symphony payment amount
Theater, ballet, symphony payment period
Media rentals payment amount
Media rentals payment period
Media purchases payment amount
Media purchases payment period
Cable television payment amount
Cable television payment period
Athletic organizations payment amount
Athletic organizations payment period
Country club payment amount
Country club payment period
Health club payment amount
Health club payment period
Athletic equipment payment amount
Athletic equipment payment period
Hobbies payment amount
Hobbies payment period
Music/dance lessons payment amount
Music/dance lessons payment period
Sports lessons payment amount
Sports lessons payment period
Birthday parties payment amount
Birthday parties payment period
Slip charges payment amount
Slip charges payment period
Hangar charges payment amount
Hangar charges payment period
Boat storage payment amount
Boat storage payment period
Other expense 1 title
Other expense 1 payment amount
Other expense 1 payment period
Other expense 2 title
Other expense 2 payment amount
Other expense 2 payment period
Other expense 3 title
Other expense 3 payment amount
Other expense 3 payment period

Insurance expenses information:
Life payment amount
Life payment period
Homeowners/tenants payment amount
Homeowners/tenants payment period
Fire, theft and liability payment amount
Fire, theft and liability payment period
Automotive payment amount
Automotive payment period
Umbrella policy payment amount
Umbrella policy payment period
Medical plan payment amount
Medical plan payment period
Medicare payment amount
Medicare payment period
Prescription plan payment amount
Prescription plan payment period
Dental plan payment amount
Dental plan payment period
Optical plan payment amount
Optical plan payment period
Long term care payment amount
Long term care payment period
Disability payment amount
Disability payment period
Worker's compensation payment amount
Worker's compensation payment period
Motorcycle payment amount
Motorcycle payment period
Boat/watercraft payment amount
Boat/watercraft payment period
Pilot payment amount
Pilot payment period
Other expense 1 title
Other expense 1 payment amount
Other expense 1 payment period
Other expense 2 title
Other expense 2 payment amount
Other expense 2 payment period
Other expense 3 title
Other expense 3 payment amount
Other expense 3 payment period

Unreimbursed medical expenses information:
Medical payment amount
Medical payment period
Dental payment amount
Dental payment period
Optical payment amount
Optical payment period
Orthodontia payment amount
Orthodontia payment period
Pharmaceutical payment amount
Pharmaceutical payment period
Hospital payment amount
Hospital payment period
Home health care payment amount
Home health care payment period
Nursing home payment amount
Nursing home payment period
Veterinarian payment amount
Veterinarian payment period
Chiropractic payment amount
Chiropractic payment period
Massage therapy payment amount
Massage therapy payment period
Physical therapy payment amount
Physical therapy payment period
Acupuncture payment amount
Acupuncture payment period
Other expense 1 title
Other expense 1 payment amount
Other expense 1 payment period
Other expense 2 title
Other expense 2 payment amount
Other expense 2 payment period

Miscellaneous expenses information:
Beauty parlor/barber payment amount
Beauty parlor/barber payment period
Cosmetics and perfumes payment amount
Cosmetics and perfumes payment period
Tobacco products payment amount
Tobacco products payment period
Children's allowances payment amount
Children's allowances payment period
Gifts payment amount
Gifts payment period
Charitable donations payment amount
Charitable donations payment period
Commutation and transportation payment amount
Commutation and transportation payment period
Veterinarian/pet expenses payment amount
Veterinarian/pet expenses payment period
Religious contributions payment amount
Religious contributions payment period
Union dues payment amount
Union dues payment period
Postage and delivery payment amount
Postage and delivery payment period
Mail box rental payment amount
Mail box rental payment period
Stationery payment amount
Stationery payment period
Bank fees payment amount
Bank fees payment period
Check fees payment amount
Check fees payment period
Other expense 1 title
Other expense 1 payment amount
Other expense 1 payment period
Other expense 2 title
Other expense 2 payment amount
Other expense 2 payment period
Other expense 3 title
Other expense 3 payment amount
Other expense 3 payment period

Other expenses information:
Other expense 1 title
Other expense 1 payment amount
Other expense 1 payment period
Other expense 2 title
Other expense 2 payment amount
Other expense 2 payment period
Other expense 3 title
Other expense 3 payment amount
Other expense 3 payment period
Other expense 4 title
Other expense 4 payment amount
Other expense 4 payment period
Other expense 5 title
Other expense 5 payment amount
Other expense 5 payment period
Other expense 6 title
Other expense 6 payment amount
Other expense 6 payment period
   Other Information

Other data identifies all remaining financial and legal amounts and agreements in the case, including support, counsel fee, accountant and appraisal fee, and other financial information. The invention's other information comprises the following data elements.

Support requirements information:
Paying/receiving
Paid/received amount
Paid/received amount payment period
Paid/received prior to separation
Paid/received pre-sep amount
Paid/received pre-sep payment period
Covered expenses
Reason for payment
Arrears outstanding?
Arrears outstanding amount
Deponent requested amount per child
Deponent child amount payment period
Number of children to receive support
Deponent requested amount for self amount
Deponent self amount payment period
Payment day interval
Payment day of week

Counsel fee requirements information:

Deponent amount requested for fees and disbursements
Deponent amount paid to counsel
Deponent fee agreement with counsel
Retainer or written agreement concerning fees?

Accountant and appraisal fee requirements information:
Deponent requested amount for accountant fees and disbursements
Reason for requiring accountant
Deponent requested amount for appraiser fees and disbursements
Reason for requiring appraiser

Other financial information:
Explanation of other financial information
   General Conveniences

The invention uses commonly-available interface components to simplify entry of certain types of information. An example is the use of a calendar icon to navigate to, and select, a specific date, as contrasted with requiring the typing of individual day, month, and year for the item of information requiring date contents.

Summary

The proper completion of the Statement of Net Worth (SNW) for a matrimonial divorce proceeding can be a long and complex process. The SNW requires entry of data elements originating throughout the entire history of the marriage. An example might be the original prices or values of specific assets acquired during the marriage. The SNW also may require data elements originating before the marriage as well, such as the original prices or values of specific assets acquired before the marriage. The SNW also requires entry of numerous monetary amounts to form consistent patterns, such as the purchase price of the primary residence, which must match the sum of the cash down payment and the amount of the mortgage. The SNW also requires the summarization of various breakdowns of monetary amounts, such as the sum of all food expenses over a month's time, as produced from the individual categories of food expense such as groceries, lunches at work, alcohol, and other categories as supplied by the user. Further, the SNW requires some open-ended lists of sets of entries, such as the name, date of birth, ages, SSN, and place of residence of each of a number of children that varies widely from case to case. For some data elements, the SNW further requires that the user choose from one of a set of valid alternatives.

These data requirements vary widely from case to case. During a divorce action, the cost of preparing the SNW can itself become an issue, and providing a reasonably-accurate estimate for preparation is highly desirable. In a simple divorce action in which no children, a short marriage history, few assets, few expenses, and few sources of income are involved, the Statement of Net Worth can be prepared quickly and easily. In a more complex divorce action in which, for example, the division of businesses and considerable wealth are factors, the preparation of the SNW becomes complicated, and its accuracy becomes critical. The invention significantly reduces the difference in degree of difficulty of preparation between these two extremes. This reduction eases the task of estimation for the preparer of the SNW.

Law firms handling matrimonial actions have been generally slow to adopt computerized forms. This slowness is based in part in the perception, often correct, that such forms and their supporting software are often inadequate or incomplete in their coverage of necessary details, and are difficult to use. Since inaccuracy and omission can result in expensive legal errors, and since difficulty of use contributes to those errors, law firms have resisted the adoption of computerized systems for form preparation. The invention is comprehensive, precise, and easy to use, facilitating the adoption of its automated features by law firms that have resisted the use of other computerized systems.

What is claimed is:

1. An apparatus for producing a legal statement of net worth for a couple, comprising:
a computer, further comprising a processor, a main memory, a storage subsystem for keeping a database, a display device, a pointing device, a device for entering data, and a printer;
a client net worth database further comprising a set of database tables containing net worth data for one or more clients;
a database system operating on the computer for storing and retrieving client net worth data in the database for one or more clients;
one or more client net worth forms to be displayed on the display device for data viewing and client net worth data entry by a user;
one or more menus to be displayed on the display device to allow the user to select a client net worth form to be displayed;
a user interface software program operating on the computer for displaying client net worth forms and data on the display device and accepting client net worth data from the pointing device and the device for entering data;
a database interface software program operating on the computer for sending output client net worth data retrieved from the database via the database system to the user interface software program for display, and for receiving input client net worth data from the user interface software program and sending said input client net worth data to the database via the database system for storage in the database; and
a reporting software program operating on the computer for retrieving, formatting, and printing client net worth information in the database.

2. The apparatus of claim 1 wherein each of the set of database tables further comprises one or more client data items.

3. The apparatus of claim 2 wherein the user interface software program presents closely related client data items in a single client net worth form for the user wherever possible.

4. The apparatus of claim 2 wherein the user interface software program presents a minimum necessary number of client net worth forms to the user.

5. The apparatus of claim 2 wherein the user interface software program presents to the user only those client net worth forms required for a specific case.

6. The apparatus of claim 2 wherein the user interface software program requests and stores the user's count of occurrences of a particular data item.

7. The apparatus of claim 6 wherein the user interface software program uses the user's count of occurrences of a particular data item to present exactly the number of client net worth forms needed to obtain or review all required information.

8. The apparatus of claim 2 wherein the user interface software program provides a navigation menu to allow a user to display any desired client net worth form.

9. The apparatus of claim 2 wherein the user interface software program uses drop-down menus of standard phrasings and choices used in the production of a legal Statement of Net Worth.

10. The apparatus of claim 2 wherein the user interface software program tracks and subtotals values in all categories and subcategories of net worth, accumulating the values of data items in all categories into a summary statement of total assets, total liabilities, and net worth.

11. The apparatus of claim 1 wherein the user interface software program validates text and numeric values entered by the user.

12. The apparatus of claim 1 wherein the user interface software program uses information gathered in one category to simplify the gathering of information in another category.

13. A software apparatus for producing a legal statement of net worth for a couple, comprising:
a computer, further comprising a processor, a main memory, storage means, display means, pointing means, a means for entering data, and means for printing;
a means for storing and retrieving net worth data for one or more clients;
a means for displaying client net worth data on the display means and accepting client net worth data from the pointing means and the means for entering data;
one or more forms to be displayed on the display device for net worth data viewing and client net worth data entry by a user;
one or more form selection means;
a report generation means.

14. A method of producing a complete legal statement of net worth for a couple, comprising the steps of:
identifying a client;
gathering complete case information for the couple;
storing the case information in a database;
updating the case information in the database;
summarizing the case information in the database;
producing a statement of net worth report of the case information and summarized case information in the database; and
printing the statement of net worth report.

15. The method of claim 14, wherein the step of gathering complete case information further comprises the steps of:
gathering case information for the couple;
gathering child information for the couple;
gathering plaintiff information for the couple;
gathering defendant information for the couple;
gathering housing information for the couple;
gathering income and benefits information for the couple;
gathering asset information for the couple;
gathering liability information for the couple;
gathering expense information for the couple; and
gathering other case information for the couple.

16. The method of claim 14, wherein the step of gathering complete case information further comprises the steps of:
obtaining occurrence counts for specific categories of information;
storing the occurrence counts; and
applying the occurrence counts to limit the number of displays presented to the user.

17. The method of claim 14, wherein the step of gathering complete case information further comprises the steps of:
retaining information gathered in one or more categories;
applying the information in one or more other categories to limit the number of displays presented to the user; and
applying the information in one or more other categories to limit the amount of data entry required for the user.

18. The method of claim 14, wherein the step of gathering complete case information further comprises the step of presenting to the user drop-down menus containing accurate legal phrasings for storage as data element values.

19. The method of claim 14, wherein the step of gathering complete case information further comprises the step of using a navigation menu to select directly a specific category of data for entry.

20. The method of claim 14, wherein the step of gathering complete case information further comprises the step of retaining and accumulating monetary values for presentation in a report of net worth.
